(19) United States
(12) Patent Application Publication
(10) Pub. No.: US 2006/0053136 A1
(43) Pub. Date: Mar. 9, 2006

(54) Method and system for analyzing multidimensional data

(76) Inventor: Amir Ashiri, Sunnyvale, CA (US)

Correspondence Address: NATH & ASSOCIATES, PLLC;Sixth Floor, 1030 15th Street, N.W., Washington, DC, 20005, US

(21) Appl. No.: 11/199,383

(22) Filed: Aug. 9, 2005

Related U.S. Application Data
(60) Provisional application No. 60/599,572, filed on Aug. 9, 2004.

(51) Int. Cl. G06F 7/00

(52) U.S. Cl. 707/101

(57) ABSTRACT

A method and system for analyzing multidimensional data. The method comprises assigning an exceptionality score to one or more nodes in the multidimensional data and identifying one or more exceptional nodes among the scored nodes. One or more focal point nodes are then identified from among the exceptional nodes, where a focal point node is an exceptional node whose coordinates define a location at which an event occurred that caused the node to be exceptional. The invention also provides methods for identifying focal nodes. Methods for scoring a multidimensional are also provided.

This application claims the benefit of prior U.S. provisional patent application No. 60/599,572 filed Aug. 9, 2004, the contents of which are hereby incorporated by reference in their entirety.

### FIELD OF THE INVENTION

This present invention relates to methods and systems for analyzing multidimensional data.

### BACKGROUND OF THE INVENTION

Business and other users, managers, researchers and analysts continuously search for tools allowing them to answer questions on, and to get insight from, their data. Typically, these activities are referred to as tasks of “Business Intelligence” (BI). BI involves gathering, storing, analyzing and reporting information, where information is obtained from a variety of sources both inside and outside of the organization. BI is aimed at improving the effectiveness, efficiency and quality of decision making processes.

There are two main categories of such tools: reporting, both predefined and ad-hoc, and data mining. At the high end of ad-hoc reporting are Online Analytical Processing (OLAP) tools. OLAP is the name given to a set of technologies and applications that collect, manage, query, process, summarize, consolidate, and present multidimensional data for analysis and management purposes. OLAP is either based on a Multidimensional Database (MDDB), in which case it is called MOLAP (multidimensional OLAP) or on a relational database (in which case it is called Relational OLAP, or ROLAP). The complexity of queries and the need to query large data sets have caused MOLAP, with its MDDBs, which allow direct manipulation of multidimensional data, to grow in popularity.

One of the main goals of OLAP is to help managers and analysts gain insight into the performance of their enterprise. In particular, users have tried to use OLAP tools for detection of unexpected business behavior requiring attention. This is done in the form of a manual exploration process, where queries are issued against the data in an attempt to find answers to particular questions, and where each query result iteratively leads to the next query. This exploration process is associated with a user-directed navigation through the multidimensional data space, as directed by query results.

Data mining, also known as Knowledge Discovery in Databases (KDD), while used with varied meaning, may be defined as “the practice of automatically searching large stores of data for patterns”. While OLAP tools are used by sophisticated end users and analysts for visual, multi-purpose, navigational, online exploration of data, data mining is used by specialists, who are experts in mathematical and statistical modeling, to provide answers to very specific questions.

A multi-dimensional data space is sometimes referred to as a “data cube”. FIG. 1 shows, as an example, a 3-dimensional data cube 10. Each of the three axes of the cube is assigned a “feature attribute” or “dimension”. The feature attributes in this example are “product” 12, “country” 14 and “year” 16. The possible values of a feature attribute are referred to as the “coordinates” of the feature attribute. Thus, for the data cube shown in FIG. 1, the feature attribute “product” 12 has the four coordinates of “milk” 12a, “cottage cheese” 12b, “yogurt” 12c and “yellow cheese” 12d. The coordinates of “country” 14 are “UK” 14a, “USA” 14b and “Japan” 14c, and the coordinates of “year” 16 are “2001” 16a, “2002” 16b, and “2003” 16c.

More generally, an n-dimensional data cube has n associated feature attributes, and each cell in the cube corresponds to a unique combination of coordinates from the n feature attributes. Each data cell in the cube is thus identified by means of its n coordinates, i₁, i₂, . . . iₙ, where iₖ is a coordinate of the k-th dimension. Each cell of the data cube corresponds to a unique combination of one coordinate of each feature attribute (i.e. a particular product, country and year, in the example of FIG. 1). One or more data values occupy each cell in the cube. A data value occupying the cell having the coordinates i₁, i₂, . . . iₙ, is denoted herein as a_{i1i2 . . . in}, and is a measure assigned to the combination of coordinates i₁, i₂, . . . iₙ of the cell. In the example of FIG. 1, the measure of a cell may be, for example, the sales in dollars of the product in the country and year of the cell.

Additionally, in a multidimensional database, aggregate levels are defined providing different levels of resolution for viewing the data. Referring again to the Example of FIG. 1, “sales of milk during 2003 (in all countries)”, is a higher order aggregate level of the data that includes all of the cells in the 1-dimensional section (i.e. the row) of the data cube having “milk” and “2003” as coordinates. Similarly, “sales of milk during all years and in all countries” is a higher order aggregate level of the data that includes all of the cells in 2-dimensional (planar) section of the data cube having “milk” as a coordinate. Thus, an “m-dimensional aggregate” is a set of data cells in which m of the feature attributes take on any of their coordinate values, while each of the remaining n-m feature attributes take on a single specified coordinate.

In order to be able to study aggregate levels, it is convenient to add to one or more dimensions of the data cube a coordinate referred to herein as “all”. FIG. 2 shows a data cube 20 obtained by adding an “all” coordinate 22a, 22b and 22c to the feature attribute product 12, country 14 and year 16, respectively of the data cube 10 of in FIG. 1. For a given cell having a set s of attributes having the coordinate “all”, the measure occupying the given cell is an aggregate function of the measure values of all cells having the same coordinates as the given cell in all attributes not in s, and any one of the allowed coordinates in all attributes that are in s. Such aggregate functions will often be SUM (summing the measure values) but may also be MAX, MIN and COUNT, as well as others.

The data represented by a multidimensional cube can also be represented in the form of a directed acyclic graph (DAG) in which the cells correspond to nodes arranged in multiple hierarchies (in fact, partial hierarchical views into the DAG) according to the number of “all” coordinates of the cells. FIG. 3 shows the cells of the data cube 20 of FIG. 2 having the year coordinate “2003” arranged in a hierarchy 30. The cells of the data cube of FIG. 2 having the year coordinate “2002” and “2001” may be arranged in similar hierarchies. The lowest level 32 of the hierarchy, 30 consists of the 12 cells of the data cube of FIG. 2 having time (year) coordinate 2003 and no “all” coordinates. Immediately above the level 32 in the hierarchy 30 is a level 34 consisting of the 7 cells of the data cube 20 having time (year) coordinate 2003 and exactly one “all” coordinate. Four of the cells in the level 34 have an “all” coordinate for the country feature attribute, while three of the cells in the level 34 have an “all” coordinate for the product feature attribute. Immediately above the level 34 in the hierarchy 30 is a level 36 consisting of the one cell 39 in the data cube 20 having time (year) coordinate 2003 and two “all” coordinates (for the product and country feature attributes). In the hierarchy 30, a given cell in the level 34 having one “all” coordinate is joined by a directed edge from each of the cells in the level 32 having the same “specified” coordinates of the given cell. For example, the cell (all, milk, 2003) 33 in the level 34 is joined by a directed edge to each of the cells (Japan, milk, 2003) 35a, (UK, milk, 2003) 35b and (USA, milk, 2003) 35c in the level 32. Similarly, all the cells in the level 34 are joined by a directed edge into the cell 39 in the level 36. However, the cell (Japan, milk, 2003) 35a in the level 32 is joined by a directed edge to two cells in the level 34: (all, milk, 2003) 33 and (Japan, all, 2003) 37.

More generally, the cells in an n-dimensional data cube may be viewed as a DAG having n aggregate levels in which the nodes in the m-th level have exactly m “all” coordinates, for m=0 to n−1. A given cell in the m-th level joins by a curve all cells in the (m−1)-th level having the same “specified” coordinates as the given cell. The measure attribute of a given cell in the m-th level of the DAG is thus an aggregate function of the measure attributes of the cells in the (m−1)-th level which the given cell joins. A cell at the lowest level of the DAG (e.g. the level 32 in the DAG 30) has no “all” coordinates and is referred to herein as a “leaf” of the DAG. A cell in the mth level of the DAG, for m from 1 to n−1, is referred to herein as a “level m node” in the DAG. For an m level node joining one or more m−1 level nodes, the m level node is referred to herein as the “parent” of the m−1 nodes which it joins, and the m−1 level nodes are referred to herein as the “children” of the m level node.

In addition to the above described aggregation hierarchy, a data cube may also contain dimension-specific aggregation hierarchies of allowed associations between the non-key attributes of the dimension, for one or more dimensions. For instance, a Product hierarchy may be defined for the Product dimension. For example, the product dimension may have attributes ProductType (with values such as Low Fat (1%) cottage cheese, Nonfat Strawberry Yogurt, skim milk, etc.), ProductCategory (with values such as Cottage cheese, soft cheese, milk, etc.) and ProductFamily (dairy products, fruit & vegetables, canned products, etc.), a hierarchy may be defined for Product, where each product has a ProductType (typically one), each ProductType belongs to a ProductCategory (typically one), and each ProductCategory belongs to a ProductFamily (typically one).

As indicated above, the goal of data exploration is often to detect situations that the user needs to act upon. Such situations are revealed by data values that the user did not expect. Problems and/or new opportunities are often identified when an unexpected data value is identified in the data. OLAP, however, is merely a navigational tool that allows the user to navigate through the data cube in order to search for unexpected data values. OLAP is not designed to find unexpected data values.

Data values referred to as “exceptional values”, “exceptions”, “anomalies”, or “deviations” are data values that are significantly different from an expected or predicted value. Exceptions may be identified by assigning to one or more data values in the data cube a score indicative of the extent of exceptionality of the data value. For example, a score may be assigned to a data value by comparing that data value to a predicted value. The expression “Fₚ(i₁, i₂, . . . iₙ,)” is used herein to denote a predicted value of the data value aᵢ_{₁}_{, i}_{₂}_{, . . . i}_{ₙ} the cell in a data cube having the coordinates i₁, i₂, . . . iₙ. A score may be assigned to the data value equal to the residual R(i₁, i₂, . . . . iₙ) which is the difference between the prediction and the actual measured value, i.e., R(i₁, i₂, . . . iₙ)=Fₚ(i₁, i₂, . . . iₙ,)−aᵢ_{₁}_{, i}_{₂}_{, . . . , i}_{ₙ}. The score may be the absolute value of the residual and may be normalized, for example by dividing it by the standard deviation of the residuals. One important purpose of the normalization is to produce a residual that is independent of the specific representation of the data (independent of whether a measure is given, for example, in meters, feet, or centimeters), so that it may be compared with other residuals.

One way to determine whether a data value constitutes an exception is to compare it's score to a threshold. If the score is above the threshold, the data value is considered to be an exception. For data values that are known to be nearly normally distributed, the threshold may be defined as a predetermined number of standard deviations from the mean.

U.S. Pat. No. 5,813,002 to Agrawal et al. discloses a method for detecting deviation in a database in which a similarity function is defined on a set of data items by considering the frequency of the values of each attribute. A subset is considered to be a deviation if it has a large influence on the similarity function in comparison to influence of the entire set on the similarity function.

U.S. patent application Ser. No. 10/165,322 of Keller et al. having the publication No. 2003/0028546 discloses a method for determination of exception in multidimensional data using an ANOVA based multivariate data analysis. A residual for each cell of the set of cells in then determined. The residuals are scaled and the scaled residuals are then compared with a threshold value for determination of an exception.

U.S. Pat. No. 6,094,651 to Agrawal et al., discloses a method for exploration of a data cube using a search for anomalies that is based on exceptions found at various levels of data aggregation. A “surprise value” is associated with each cell of the data cube, and an anomaly is indicated when the surprise value associated with a cell exceeds a predetermined exception threshold. The surprise value associated with a cell is based on a “Self-Exp value” for the cell, an “In-Exp value” for the cell and a “Path-Exp value” for the cell. The Self-Exp value for a cell represents a degree of anomaly of the cell with respect to other cells at a same level of aggregation in the data cube, while the In-Exp value for the cell represents a degree of anomaly underneath the cell in the data cube, and the Path-Exp value for the cell represents a degree of surprise for each respective drill-down path in the data cube from the cell. The In-Exp value for the cell can be a maximum surprise value associated with all cells in the data cube underneath the cell, or alternatively, can be a sum of surprise values associated with all cells in the data cube underneath the cell. The Path-Exp value for the cell is based on a drill-down path having a fewest number of high value In-Exp cells in the data cube underneath the cell.

The publication Inmaculada B. Aban, Mark M. Meerschaert, and Anna K. Panorska “Parameter Estimation for the Truncated Pareto Distribution” discloses a method for obtaining a maximum likelihood estimator (MLE) for a truncated Pareto distribution (this publication may downloaded at http://www.maths.otago.ac.nz/˜mcubed/TPareto.pdf).

### SUMMARY OF THE INVENTION

The presence of exceptional data values in multidimensional data can often be attributed to the occurrence of one or more events that affected at least some of the scores of the data values. The present invention is based upon the finding that the effect of a real life event on a data value may be direct or indirect, making it difficult to detect the actual location of occurrence of this event from the data.

For example, referring again to the hierarchical view 30 of the multidimensional data shown in FIG. 3, a problem in the Japanese dairy industry in 2003 might cause the sale of most dairy products in Japan to be significantly lower in 2003 in comparison to previous years. The problem is captured through the leaves, so that the leaf nodes 35a, 40, and 41 would all be identified as exceptions. The first level node 37 (having coordinates Japan, 2003 and all products) that is a parent node to the leave nodes 35a, 40, and 41, would also be identified as an exception. Another hypothetical event, such as a release of a US report describing risks associated with milk consumption, might cause a sharp decrease in milk sales in the US, causing node 35c to drop unexpectedly. Due to the drop in sales of milk in Japan in 2003 (node 35a), driven by the first event, and the drop in the sales of milk in the US in 2003, resulting from the second event, the node 33 (having the coordinates all countries, milk, 2003), might also manifest a drop and be identified as an exception, even though it is not the actual location of occurrence of any of those events. Thus, an event (a problem in the diary industry in Japan in 2003) that actually occurred on node 37 and another event (release of the report in the US) occurring on node 35c, in addition to directly causing the nodes associated with their occurrence location to be exceptional, also caused, indirectly, the node 33 to be exceptional. Furthermore, the exceptionality appeared on the node 37 as well as on its leaves, where the exceptionality of the these leaves is not the result of events occurring on them but rather an indirect influence of the event occurring on node 37.

An event affecting data measures is considered as occurring at a location identified by the coordinates of one of the cells of the data cube. Thus, the event “a problem in the Japanese dairy industry in 2003” occurred a the location (Japan, all, 2003). Similarly, the event “release of a US report describing risks associated with milk consumption” occurred at the location (US, all, 2003). As shown in the example above, an event occurring at a particular location (i.e. node in the hierarchy) can effect the data value (and hence the exceptionality score) of that node as well as the data value and exceptionality of other nodes.

An exceptional node, the coordinates of which define the location of occurrence of a real life event, is referred to herein as “a focal point of the event”. A focal point of an event is thus a node that is directly affected by the event. Although prior art methods of multidimensional data analysis disclose methods for identifying exceptions, the prior art does not disclose distinguishing between exceptional nodes that are focal points and those that are not, and obviously does not attempt to detect such focal points.

Thus in its first aspect, the present invention provides a method for analyzing multidimensional data. In accordance with this aspect of the invention, one or more exceptions are identified in the data and one or more focal points are identified among the exceptions.

In it second aspect, the present invention provides a method for analyzing multidimensional data. In accordance with this aspect of the invention, one or more exceptions are identified in the data and one or more exceptional data values that are not focal points are identified among the exceptions.

In its third aspect, the invention provides a method for identifying one or more focal points from among a set of one or more exceptional points. In accordance with this aspect of the invention, an exceptionality score on an exceptional node e is considered as a function of two components. One component, referred to herein as the “direct component”, represents the direct contribution of exceptionality by an event occurring in the location defined by node e's coordinates to e's score. The other component, referred to herein as the “indirect component”, represents indirect contributions of exceptionality by events occurring on other nodes to node e's score. Those indirect contributions of exceptionality result from interactions of domains within the real world environment that are manifested through interactions between node e and other nodes in the database. As demonstrated in the above example, a node n may affect the score of another node e when there exists a node, and thus a set of leaves, that are descendents of both nodes e and n. The node that is the unique highest level descendent node of both e and n is denoted herein as e*n, and is referred to as “the intersection of e and n”. Similarly, the set of nodes that are descendents of both e and each node n in a set N of nodes such that e and n intersects is denoted herein as e*N, and are referred to as “the intersection of e and N”. Through these intersections nodes can interact with one another, propagating exceptionality from one node to another.

The method of the invention may be applied to any multidimensional database for which one or more exceptionality scores have been assigned to at least some of the data values, and exceptions have been identified. The method of the invention may be used together with any method for assigning exceptionality scores to the nodes of the database, and any method for identifying exceptional nodes among the scored nodes. In fact, the method of this invention may be applied to multiple exceptionality scores concurrently.

The invention also provides a method for determining exceptionality scores to an n-dimensional data cube in which each cell has coordinates i₁, i₂, . . . , iₙ₋₁, iₙ=t, wherein, for instance, the n-th feature attribute is time and has as coordinates the k times t₁, to tₖ. The times t₁ to tₖ are arranged chronologically, so that tⱼ<tₗ whenever j<l. In accordance with this aspect of the invention, exceptionality scoring of the data points is carried out as follows. Using the hierarchical view of the cube (as shown, for example, in FIG. 3), for each one of the lowest p hierarchy levels starting at the leaves, a score is assigned to one or more cells of the data cube level having as a time coordinate tₖ (i.e. cells relating to the latest time among the coordinates of the time feature attribute). These cells have coordinates of the form i₁, i₂, . . . iₙ₋₁, iₙ=tₖ. The expected value Fp(i₁, i₂, . . . , iₙ₋₁, iₙ=tₖ) of aᵢ_{₁}_{, i}_{₂}_{, . . . i}_{_{n−1}}_{, i}_{ₙ}₌ₜ_{ₖ} on node i₁, i₂, . . . , iₙ₋₁, iₙ=tₖ is obtained in a calculation involving one or more of the data values aᵢ_{₁}_{, i}_{₂}_{, . . . , i}_{_{n−1,}} ᵢ_{ₙ}₌ₜ_{ⱼ} in the cells i₁, i₂, . . . , iₙ₋₁, iₙ=tⱼ where j<k. That is, the expected value obtained for node i₁, i₂, . . . , iₙ₋₁, iₙ=tₖ is based upon data values associated with times earlier than tₖ. The time dimension is thus dealt with as an ordered value sequence, and not as categorical dimension. The time series may be processed prior to calculating scores, for example, in order to remove outliers, compensate for missing data points, or smooth the input data for elimination of noise.

A score Wᵢ_{₁}_{, i}_{₂}_{, . . . , i}_{_{n−1}}_{, i}_{ₙ}₌ₜ_{ₖ}, calculated for a node, compares the expected value Fp(i₁, i₂, . . . , iₙ₋₁, iₙ=tₖ) to the actual data value aᵢ_{₁}_{, i}_{₂}_{, . . . , i}_{_{n−1}}_{, i}_{ₙ}₌ₜ_{ₖ} of the node in order to determine whether the data value aᵢ_{₁}_{, i}_{₂}_{, . . . , i}_{_{n−1}}_{, i}_{ₙ}₌ₜ_{ₖ} indicates an exception. For example, the score may be |aᵢ_{₁}_{, i}_{₂}_{, . . . , i}_{_{n−1}}_{, i}_{ₙ}₌ₜ_{ₖ}−Fp(i₁, i₂, . . . , iₙ₋₁, iₙ=tₖ)| or a function of this difference, and the data value aᵢ_{₁}_{, i}_{₂}_{, . . . , i}_{_{n−1}}_{, i}_{ₙ}₌ₜ_{ₖ} may be determined to be an exception if f(|aᵢ_{₁}_{, i}_{₂}_{, . . . , i}_{_{n−1}}_{, i}_{ₙ}₌ₜ_{ₖ}−Fp(i₁, i₂, . . . , iₙ₋₁, iₙ=tₖ)|) exceeds a predetermined threshold.

The predicted value Fp(i₁, i₂, . . . , iₙ₋₁, iₙ=tₖ) may obtained, for instance, by a linear regression analysis of the possibly smoothed time series of measures aᵢ_{₁}_{, i}_{₂}_{, . . . , i}_{_{n−1}}_{, i}_{ₙ}₌ₜ_{ⱼ} using a time window of two or more time points tⱼ<tₖ. The residual R of the linear regression at time tₖ may be used as an exceptionality score, referred to herein as the “magnitude of the exceptionality”.

In addition, the residual R may be normalized so that it can be compared to a threshold based on a global historic data (across multiple nodes). The Normalized R may be used as a score referred to herein as “the strength of the exceptionality”. The percentile of the residual in the order statistics of the residuals of times t₁ to tₖ may also be used to indicate the strength of the exceptionality.

The predicted value may also be obtained by any other regression method such as a higher order regression or spline regression, as well as non-regression techniques such as double exponential smoothing (for example, the Holt method). Other techniques, not involving an explicit prediction model, may also be used to directly obtain the exceptionality score, such as Bayesian methods, including Hidden Markov Models (HMM).

The time series may be processed after obtaining the scores, possibly resulting in adjustment of these scores. For example, pattern analysis may be conducted, in which patterns indicating a need to adjust the score are detected, and based on them the scores are adjusted. For instance, processing may look for transient phenomena that is canceled and compensated for in the time series right after its occurrence (such as an increase in the data values followed by a restoring decrease); The processing may also include adjustment of scores to remove phenomena attributable to seasonality and other periodic effects, recurrence and continuation of earlier exceptions, as well as return to normal value base line after a period of deviation. After this processing is completed, the data values may be rescored, and exceptional data values identified based upon the rescoring. The method of the invention is then applied to identify data values that are focal points, or data values that are not focal points.

Node scoring models, such as the prediction-based models mentioned above, may be applied directly to each node at the lowest p levels of the cube. While p can be made as large as desired, even directly scoring the entire cube, using these procedures for large p might be problematic, due to scale (computational complexity) and robustness limitations.

First, if the cube is complex, with many billions of data point combinations, applying a scoring model to all nodes may be too heavy computationally for the scale. Second, running a scoring scheme and exceptionally search directly on aggregate nodes might, under certain circumstances, be limited in its accuracy, when the number of leaves under the aggregate node changes between time points. The accuracy may be improved to some extent if the exceptionality detection procedure is adapted to changes in the number of leaves through some heuristics. A more accurate model can also be employed, based on the Renewal Theorem, which defines the theoretic distribution of a sum of a number N (number of leaves under the aggregate node in this case) of random variables, where N is itself a random variable. However, this would involve complex calculations of the dependency between N and the sum at any point in time. In addition, the model might not be robust enough as it assumes specific dependency model.

The invention also provides a method form exceptionality scoring. In accordance with this aspect of the invention, an exceptionality scoring scheme is applied to the p lowest cube levels. p may be selected, for example, as the lowest level providing stable data. Each node in any of the remaining n-p levels is scored and exceptionality is sought for it recursively or iteratively from the nodes below it or directly from the leaves “covered” by (contained in) it. The recursive or iterative function may be, for example, a weighted average of the scores of the descendents. In a preferred embodiment of the invention, some or all of the nodes tagged as exceptional nodes this way may subsequently undergo a more elaborate analysis, involving direct scoring of the nodes. Alternatively, and more generally, different scoring schemes may be applied to cells at different sections of the cube.

Node scoring may involve measures computed from other, possibly aggregated, measures. For instance, a measure “market share” may be used, defined as the sales of one company divided by the sales of the entire “market” (the company with all of its competitors), along any combination of other dimensions. The target measure (market share) is derived here from the source (input) measure (sales volume). Unlike the input measure, this derived measure is not additive, thus must be computed directly, rather than being aggregated. In this example, this derived measure may be computed on any specific company node from that node's sales value and from the sales of the parent node along the company dimension (that is, the entire market node, in the same dimensional context as the original node).

All the nodes of the cube of which the exceptionality scores have passed the exceptionality test are considered as candidate event focal points. These candidates are the subject of the focal point detection analysis. Focal analysis is concerned with solving the interaction problem, by assessing the contribution of a set of exceptional nodes N to the score of a given exceptional node e. In accordance with the invention, the approaches taken may involve local analysis, global interaction analysis, or both.

Local analysis is focused on the most probable interactions, namely those occurring between a parent and its child nodes. It is based on the novel and unexpected observation that if a node is a focal point, it contributes exceptionality to its children quite homogenously (due to the containment relationship that exist between them). Thus a child of a focal point node may not have exceptionality that is very different from that of the child's siblings (that is, a focal point child may not be unique). Note that in real life the business domain associated with that node is composed from the business domains associated with that node's children, as derived from the aggregative structure of the cube. Intuitively, under the homogeneity observation, the higher the proportion of children and the higher the proportion of measure volume among the children exhibiting exceptionality in the same direction as the parent, the more homogenous the parent is.

Homogeneity assessment is demonstrated through a number of methods. First, statistical tests are carried on each exceptional node to test how probable it is that the exceptionality exhibited on the node's children is a result of independent events. If the independence assumption is ruled out, it is assumed that the children exceptionality is contributed by the parent. Second, a method is provided for testing that any small enough set of children (including the most exceptional ones) is not “responsible”, by itself, for a significant portion of the parent exceptionality. Third, the data is fitted to the truncated Pareto distribution, which is used to derive the homogeneity measure. Intuitively, the smaller the residual proportion “explained” by the larger volume proportion on, the lower the homogeneity. Fourth, a method to derive the homogeneity score based on analysis of the marginal contributions of the children to the parent exceptionality is presented. Finally, a method combining few of these methods is provided.

Global analysis is aimed at solving the general interaction problem. In principle, the best set of focal points is the smallest possible subset S of nodes in the set of exceptional nodes C in a cube such that the nodes in S are as exceptional as possible; the largest possible portion of the exceptionality of the nodes in S is not contributed by nodes in C\S (the complement of S in C); and the largest possible portion of the exceptionality of the nodes in C\S is contributed by nodes in S.

The basic approach would be to assess, when looking at an exceptional node e, what portion of the exceptionality of its intersection with a set of nodes N (e*N), derives from N's contribution, rather than from e, so that this portion of exceptionality can be removed from e*N, and then to assess (and possibly re-score) the remaining exceptionality in e. Conceptually, if this is done for the largest set of nodes intersecting e, the remaining exceptionality in e now approximates the net contribution of an event potentially occurring on node e to e's exceptionality, and it is expected to be high if an event has indeed occurred on e, and close to zero if not.

The interactions between nodes may be viewed as composing a directed hypergraph of dependencies. A directed hyperedge exists from a set of nodes N to e if each node n in N intersects with e and is suspected of contributing exceptionality to e through their intersection. This dependency graph may contain circles, as, for example, a node n₁ may contribute exceptionality to node n₂, n₂ may contribute exceptionality to node n₃, and n₃ may contribute exceptionality to the node n₁. The solution may apply the interaction removal process to this dependency graph.

While the solution can be based on various probabilistic network disciplines (for example, either directed or undirected Belief Networks), as the potential computational complexity is very high, an algorithmic framework that is as efficient as possible, while minimizing the impact on accuracy, is preferred. Two different methods for solving the problem are provided, together with a third one combining the two. While both base methods, in general, identify and remove exceptionality contributed through interactions, based on the interaction dependency graph, they differ in the analysis granularity.

One method is a more greedy, coarse-grained approach, in which exceptionality in an intersection e*n, at any particular time the intersection is evaluated by the algorithm, is considered to be either the contribution of e or n, the decision rules are very conclusive, and the convergence is fast. The second method is fine-grained, in which the exceptionality in an intersection e*n is considered to be partially contributed by e and partly by n, the decision mechanism is softer, allowing backtracking, and the convergence is slower. The benefit of the fine grained algorithm is also a potential weakness—while being more accurate, it may be more sensitive to interaction “noise”, caused by interactions of bad focal point nodes.

Thus, both algorithms may be combined, where the coarse grained algorithm is applied first, eliminating many of the bad focal point nodes, thus making the fine grained algorithm more effective and robust. Finally, these algorithms may run only on the set of homogenous nodes, rather than on all exceptional nodes, thus significantly improving scale.

In a preferred embodiment, focal points are identified by a gradual analysis method of the data involving high computational complexity and scale. The method successively applies filtering algorithms to an input set of nodes, suspected of being focal points, that is reduced in size from filter application to filter application, eliminating nodes from the suspect set as the process progresses. The earlier a filter is applied, the less demanding it is computationally, and, typically, the larger is the portion of the population of nodes it filters.

Prior art exceptionally scoring procedures are not sensitive enough to incorporate various patterns exhibited in the data as part of their scoring mechanism. Thus, the present invention also provides a method that applies pattern recognition detection techniques to time series data that was scored for exceptionality. Detection of such patterns help fine tune the level of confidence in the occurrence of a particular exception, based on the strength of the observed patterns. Furthermore, detection of such patterns may be used to adjust exceptionality scores either directly or by re-computing exceptionality scores after the recognized pattern effect is removed from the time series. Detecting of such patterns may result in either a decrease or an increase of the exceptionality score.

In addition, detection of such patterns may convey additional information concerning the exception. For example, in a cancellation pattern an exception is the result of a correction effect in which a deviation from the base line in one direction (e.g. an increase in value) is corrected by a later deviation of the measure value in the other direction (a decrease in value). In a Back-to-Normal pattern, a measure value returns to a previous base line after some time period during which it deviated from that base line. In a recurrence pattern, an exception recurs a number of times within some time window. In a Continuation pattern, an exception is not a spike of exceptionality but rather a continuing phenomenon.

The additional information made available when detecting such patterns is embedded through additional pattern-specific scores. Such scores may be later used for subsequent analysis.

As an example, such patterns may be used as part of a gradual focal point analysis process, where a set of filters is applied to an input set in an attempt to detect focal points of occurrence of events. Such filters narrow the population of focal point candidates, applying first coarse but light techniques that filter out a bigger portion of the population and later fine but more demanding techniques, improving the confidence in the remaining candidates.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

Thus, in its first aspect, the invention provides, a method for analyzing multidimensional data comprising:
(a) assigning an exceptionality score to one or more nodes in the multidimensional data;
(b) identifying one or more exceptional nodes among the scored nodes; and
(c) identifying one or more focal point nodes from among the exceptional nodes, a focal point node being an exceptional node whose coordinates define a location at which an event occurred that caused the node to be exceptional.

In another of its aspects, the invention provides a method for determining whether a selected exceptional node e in multidimensional data is a focal point node, the exceptional node having an exceptionality score, comprising:
(a) determining a direct component and one or more indirect components of the exceptionality score of the node e, the direct component representing a direct contribution of the an event occurring at a location identified by the coordinates of the node e, and the indirect component representing indirect contributions of events occurring at one or more locations identified by the coordinates of other nodes on the exceptionality score of the selected node; and
(b) determining whether the node e is a focal point node based upon one or both of the direct component and the one or more indirect components.

In yet another aspect, the invention provides a method for scoring a multidimensional database, one or more dimensions of the database having an “all” coordinate, the data being arranged in a hierarchy of levels according to the number of “all” coordinates of nodes in the hierarchy, comprising:
(a) assigning one or more exceptionality scores to nodes in the p lowest levels of the hierarchy, where p is an integer; and
(b) assigning one or more exceptionality scores to nodes in levels of the hierarchy above the p lowest levels in an iterative process based upon the scores assigned to the p lowest levels.

In another of its aspects, the invention provides, in an n dimensional database having a time dimension having coordinates t1 to tₖ, a method for scoring a node in the database having coordinates i₁, i₂, . . . iₙ₋₁, iₙ=tₖ, the node having an associated actual data value, comprising;
(a) predicting a value of the data value of the node i₁, i₂, . . . ,iₙ₋₁, iₙ=tₖ based upon the data values of the nodes i₁, i₂, . . . ,iₙ₋₁, iₙ=tⱼ for j from 1 to k−1; and
(b) assigning an exceptionality score to the node i₁, i₂, . . . , iₙ₋₁, iₙ=tₖ based upon the predicted value and the actual value of the node i₁, i₂, . . . ,iₙ₋₁, iₙ=tₖ.

In another of its aspects, the invention provides a program storage device readable by machine, tangibly embodying a program of instructions executable by the machine to perform method steps for analyzing multidimensional data comprising:
(a) identifying one or more exceptional nodes among the scored nodes; and
(b) identifying one or more focal point nodes from among the exceptional nodes, a focal point node being an exceptional node whose coordinates define a location at which an event occurred that caused the node to be exceptional.

The invention further provides a computer program product comprising a computer useable medium having computer readable program code embodied therein for analyzing multidimensional data the computer program product comprising:
computer readable program code for causing the computer to identify one or more exceptional nodes among the scored nodes; and
computer readable program code for causing the computer to identify one or more focal point nodes from among the exceptional nodes, a focal point node being an exceptional node whose coordinates define a location at which an event occurred that caused the node to be exceptional.

The invention also provides a program storage device readable by machine, tangibly embodying a program of instructions executable by the machine to perform method steps for determining whether a selected exceptional node e in a multidimensional array of data is a focal point node, the exceptional node having an exceptionality score, comprising:
(a) determining a direct component and one or more indirect components of the exceptionality score of the node e, the direct component representing a direct contribution of the an event occurring at a location identified by the coordinates of the node e, and the indirect component representing indirect contributions of events occurring at one or more locations identified by the coordinates of other nodes on the exceptionality score of the selected node; and
(b) determining whether the node e is a focal point node based upon one or both of the direct component and the one or more indirect components.

In yet another of its aspects, the invention provides a computer program product comprising a computer useable medium having computer readable program code embodied therein for determining whether a selected exceptional node e in a multidimensional array of data is a focal point node, the exceptional node having an exceptionality score, the computer program product comprising:
computer readable program code for causing the computer to determine a direct component and one or more indirect components of the exceptionality score of the node e, the direct component representing a direct contribution of the an event occurring at a location identified by the coordinates of the node e, and the indirect component representing indirect contributions of events occurring at one or more locations identified by the coordinates of other nodes on the exceptionality score of the selected node; and
computer readable program code for causing the computer to determine whether the node e is a focal point node based upon one or both of the direct component and the one or more indirect components.

The invention also provides a program storage device readable by machine, tangibly embodying a program of instructions executable by the machine to perform method steps for scoring a multidimensional database, one or more dimensions of the database having an “all” coordinate, the data being arranged in a hierarchy of levels according to the number of “all” coordinates of nodes in the hierarchy, comprising:
(a) assigning one or more exceptionality scores to nodes in the p lowest levels of the hierarchy, where p is an integer; and
(b) assigning one or more exceptionality scores to nodes in levels of the hierarchy above the p lowest levels in an iterative process based upon the scores assigned to the p lowest levels.

The present invention still further provides computer program product comprising a computer useable medium having computer readable program code embodied therein for scoring a multidimensional database, one or more dimensions of the database having an “all” coordinate, the data being arranged in a hierarchy of levels according to the number of “all” coordinates of nodes in the hierarchy, the computer program product comprising:
computer readable program code for causing the computer to assign one or more exceptionality scores to nodes in the p lowest levels of the hierarchy, where p is an integer; and
computer readable program code for causing the computer to assign one or more exceptionality scores to nodes in levels of the hierarchy above the p lowest levels in an iterative process based upon the scores assigned to the p lowest levels.

Also provided by the invention is a program storage device readable by machine, tangibly embodying a program of instructions executable by the machine to perform method steps for scoring in an n dimensional database having a time dimension having coordinates t₁ to tₖ a node in the database having coordinates i₁, i₂, . . . ,iₙ₋₁, iₙ=tₖ, the node having an associated actual data value, comprising;
(a) predicting a value of the data value of the node i₁, i₂, . . . ,iₙ₋₁, iₙ=tₖ based upon the data values of the nodes i₁, i₂, . . . ,iₙ₋₁, iₙ=tⱼ for j from 1 to k−1; and
(b) assigning an exceptionality score to the node i₁, i₂, . . . ,iₙ₋₁, iₙ=tₖ based upon the predicted value and the actual value of the node i₁, i₂, . . . ,iₙ₋₁, iₙ=tₖ.

The invention also provides a computer program product comprising a computer useable medium having computer readable program code embodied therein for scoring in an n dimensional database having a time dimension having coordinates t1 to tk, a node in the database having coordinates i₁, i₂, . . . ,iₙ₋₁, iₙ=tₖ, the node having an associated actual data value, the computer program product comprising:
computer readable program code for causing the computer to predict a value of the data value of the node i₁, i₂, . . . ,iₙ₋₁, iₙ=tₖ based upon the data values of the nodes i₁, i₂, . . . , iₙ₋₁, iₙ=tⱼ for j from 1 to k−1; and
computer readable program code for causing the computer to assign an exceptionality score to the node i₁, i₂, . . . ,iₙ₋₁, iₙ=tₖ based upon the predicted value and the actual value of the node i₁, i₂, . . . ,iₙ₋₁, iₙ=tₖ.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 shows a 3-dimensional data cube;

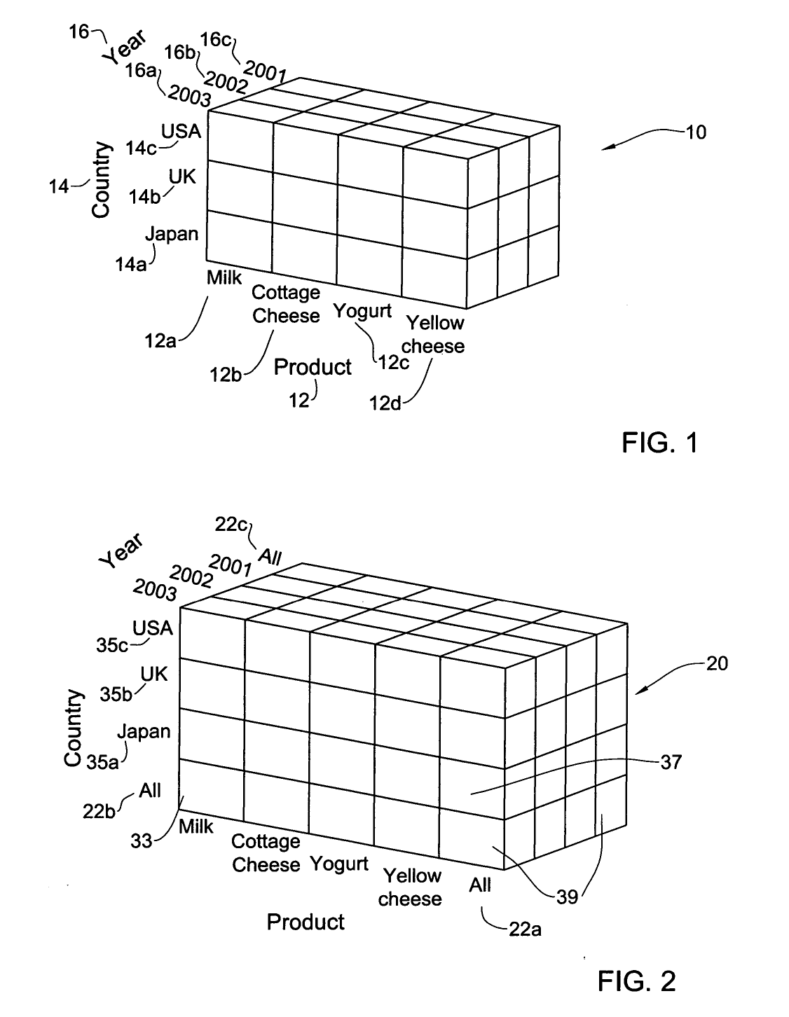

FIG. 2 shows the data cube of FIG. 1 after addition of an “all” coordinate to each of the three dimensions of the cube;

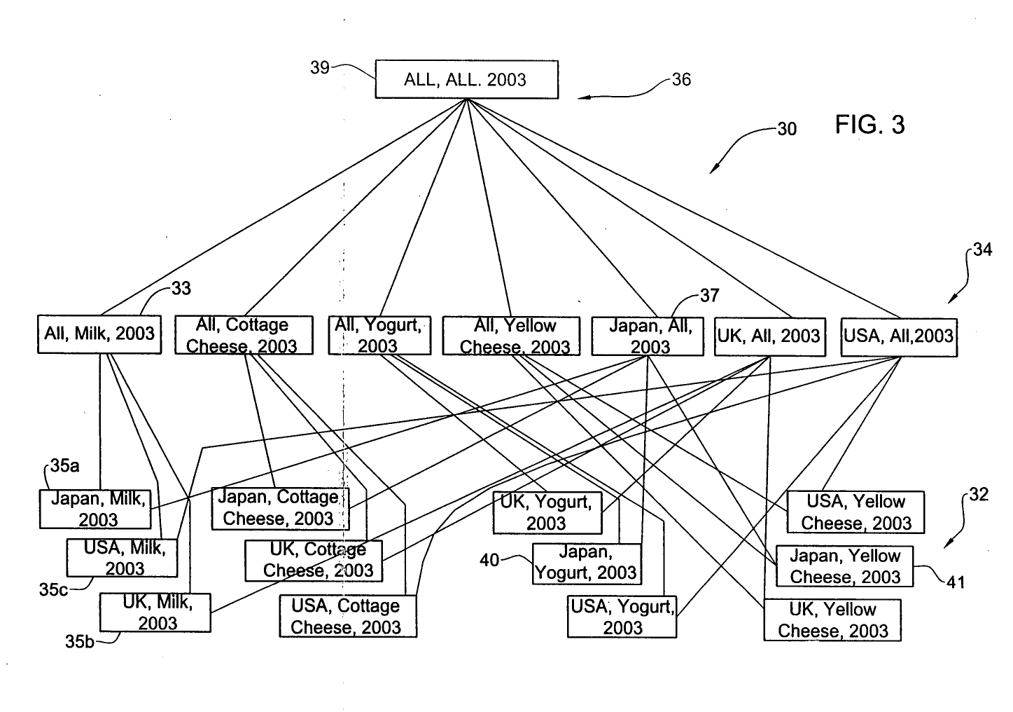

FIG. 3 shows cells of the data cube of FIG. 2 arranged in a hierarchy.

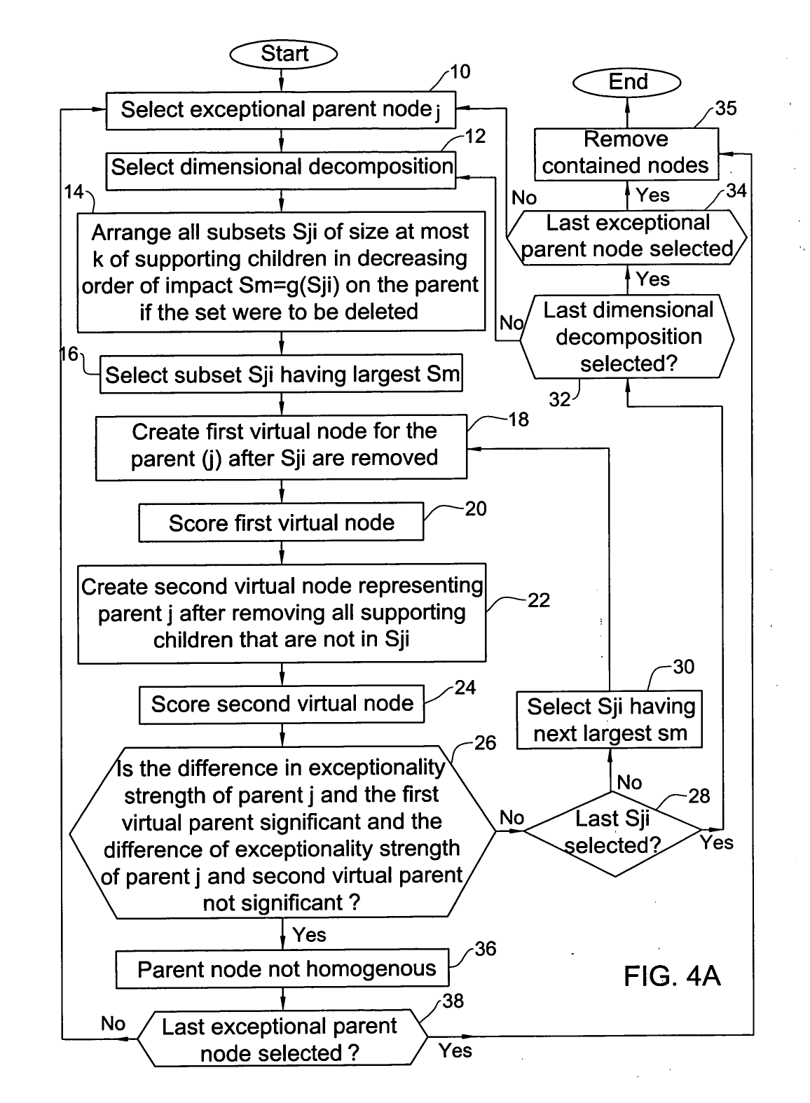

FIG. 4 shows a method for detecting focal point nodes in a multidimensional database in accordance with one embodiment of the invention;

FIG. 5 shows a method for detecting focal point nodes in a multidimensional database in accordance with a second embodiment of the invention;

FIG. 6 shows a method for detecting focal point nodes in a multidimensional database in accordance with a third embodiment of the invention;

FIG. 7 shows a method for detecting focal point nodes in a multidimensional database in accordance with a fourth embodiment of the invention;

FIG. 8 shows a method for detecting focal point nodes in a multidimensional database in accordance with a fifth embodiment of the invention;

FIG. 9 shows a method for detecting focal point nodes in a multidimensional database in accordance with a sixth embodiment of the invention;

FIG. 10 shows a state machine for use in the method of FIG. 9;

FIG. 11 shows a method for detecting a cancellation pattern in a time series of data and processing the time series;

FIG. 12 shows a method for detecting a back to normal pattern in a time series of data and processing the time series; and

FIG. 13 shows a method for detecting continuation and recurrence pattern sin a time series of data and processing the time series;

### DETAILED DESCRIPTION OF PREFERRED EMBODIMENTS OF THE INVENTION

### First Embodiment—Computing Weighted Average Based Scores

In this embodiment, scoring and exceptionality is applied to the p lowest cube levels and the remaining n-p levels are scored and exceptionality is sought either recursively or directly from the leaves “covered” by (contained in) the nodes in the n-p highest levels. p may be selected as the lowest level providing stable data. The scoring of the p lowest levels is referred to herein as “direct scoring”, and the highest level p, where direct scoring and exceptionality detection are used, is referred to herein as the “Directly-Computed Level”, or DCLevel. Thus, exceptionality of a node in any level higher than p is computed from either the DCLevel or from the level of immediate children of the node.

Any scoring scheme may be used for the direct scoring of the p lowest levels. For example, a normalized residual R^{N} may be used as the score of the p lowest levels that may be calculated may be calculated by

$${R}^{N} = \frac{{uR}_{j}}{{sR}_{j}} = \frac{R - ( \frac{{R}_{80} + {R}_{20}}{2} )}{{R}_{80} - {R}_{20}}$$

where R₈₀ and R₂₀ are the 80^{th} and 20^{th} percentiles of R respectively, computed on the node using order statistics of the historical residuals. As another example, the residual's percentile may be used as the direct score.

The exceptionality strength score of a node i in upper levels (i>p−1), referred to herein as “Mτ”, may take few forms, one of which is based on a weighted sum of the scores of nodes in either the DCLevel or the immediate children level. More specifically,

$${M}_{{τ}_{i}} = \{ \begin{matrix}{\sum }_{j ∈ {L}_{i}} {w}_{1 j} \cdot {m}_{j} / {\sum }_{j ∈ {L}_{i}} {w}_{1 j} & if i = DCLevel + 1 or base level is DCLevel \\ {\sum }_{j ∈ {K}_{i}} {w}_{2 j} \cdot {M}_{{τ}_{j}} / {\sum }_{j ∈ {K}_{i}} {w}_{2 j} & if base level is not DCLevel and i > DCLevel + 1\end{matrix}$$

Where:
Lᵢ is the set of all nodes in the DC level “under” node i
Kᵢ is the set of all immediate children of node i for any node i in levels >DCLevel+1
mⱼ is a variable calculated by the direct scoring and exceptionality analysis for node j in the DC level representing node exceptionality (see below)
M_{τ}_{ᵢ} is the indirectly computed score of node i
W₁ⱼ is the weight given to node j in the weighted sum when aggregating DCLevel nodes
W₂ⱼ is the weight given to node j in the weighted sum when aggregating from immediate children other than DCLevel nodes

$${\sum }_{j ∈ {L}_{i}} {w}_{j}$$

may also be replaced with another element, depending on the exact flavor of weighted sum used, as described below.

When computing M_{τ}_{ᵢ} from the immediate children, rather than from DCLevel, it may be necessary to aggregate the weight measure employed. When computing from a DCLevel which is not 0 (that is, it is not referring to the leaves level), computing the score for node i along the various dimensional decompositions d under node i may provide different (also close) results, and thus the final M_{τ}_{ᵢ} score should preferably be a function of scores obtained for the various dimensional decompositions under node i. When the DCLevel is 0 (whether computing directly from leaves or from immediate children) the computation may, in general, be done through any of the dimensional decompositions of τᵢ.

The DCLevel of 0 is thus preferred, unless level 0 is not stable enough or misses data points. Thus DCLevel is preferably set to the lowest level providing stable enough data. Direct scoring techniques are applied to all levels up to and including DCLevel, and all remaining levels will use the techniques described below. Note that when a level is only partially noisy, rather than increasing DCLevel, partial “artificial” aggregations of subsets of the level nodes into “other” groups may be created in order to eliminate noise.

Note that, in most cases, node i's historical data is not used in the computation of the exceptionality score, in some cases it may be necessary or desirable to compute the percentile of M_{τ}_{ᵢ} based on its historical data.

The selected computation method from those below is done for each node i in levels higher then the DCLlevel. The directly-computed exceptionality score may be obtained by any known method.

In one embodiment the smoothed input measure value maⱼ, typically based on moving averages, is used for both weights w₁ⱼ and w₂ⱼ, and the node residual percentile p(Rⱼ), are used for the exceptionality measure mⱼ.

Note that in this embodiment

$${M}_{{τ}_{i}} = {vP}_{{τ}_{i}} = \{ \begin{matrix}{\sum }_{j ∈ {L}_{i}} {w}_{1 j} \cdot {p ( R )}_{j} / {\sum }_{j ∈ {L}_{i}} {w}_{1 j} = {\sum }_{j ∈ {L}_{i}} {ma}_{j} \cdot p ( {R}_{j} ) / {\sum }_{j ∈ {L}_{i}} {ma}_{j} & if i = DCLevel + 1 or base level is DCLevel \\ {\sum }_{j ∈ {K}_{i}} {w}_{2 j} \cdot {M}_{{τ}_{j}} / {\sum }_{j ∈ {K}_{i}} {w}_{2 j} = {\sum }_{j ∈ {K}_{i}} {ma}_{j} \cdot {M}_{{τ}_{j}} / {\sum }_{j ∈ {K}_{i}} {ma}_{j} & if base level \neq DCLevel and i > DCLevel + 1\end{matrix}$$

When computing from immediate children the moving average values

$${ma}_{i} = {\sum }_{j ∈ {K}_{i}} {ma}_{j}$$

is preferably aggregated or computed directly on i.

In another embodiment, the node exceptionality magnitude (node residual) value Rⱼ is used for both weights w₁ⱼ and w₂ⱼ, and p(Rⱼ), the residual percentile is used for the exceptionality measure mⱼ. Note that

$${R}_{i} = {\sum }_{j ∈ {K}_{i}} {R}_{j}$$

(or is very close to it, depending on the exceptionality determination model used). In this case

$${M}_{{τ}_{i}} = {rP}_{{τ}_{i}} = \{ \begin{matrix}{\sum }_{j ∈ {L}_{i}} {w}_{j} \cdot p ( {R}_{j} ) / {\sum }_{j ∈ {L}_{i}} {w}_{j} = {\sum }_{j ∈ {L}_{i}} \vert {R}_{j} \vert \cdot p ( {R}_{j} ) / {\sum }_{j ∈ {L}_{i}} \vert {R}_{j} \vert & if i = DCLevel + 1 or base level is DCLevel \\ {\sum }_{j ∈ {K}_{i}} {w}_{j} \cdot {M}_{{τ}_{j}} / {\sum }_{j ∈ {K}_{i}} {w}_{j} = {\sum }_{j ∈ {K}_{i}} \vert {R}_{j} \vert \cdot {M}_{{τ}_{j}} / {\sum }_{j ∈ {K}_{i}} \vert {R}_{j} \vert & if base level \neq DCLevel and i > DCLevel + 1\end{matrix}$$

The absolute values |R|,

$${\vert R \vert}_{i} = {\sum }_{j ∈ {K}_{i}} \vert {R}_{j} \vert ,$$

should be aggregated separately from aggregating R, in order to be able to get the same scores for any dimensional decomposition of i, when computing from immediate children. As defined, the parent exceptionality score is sign-less, so it does not convey the exceptionality direction. The direction is visible through the sign of the aggregated exceptionality magnitude. Alternatively M_{τ}_{ᵢ} may be computed separately for increase and decrease events, in which case the weight will be based on the residuals, rather on their absolute values.

In another embodiment, sRⱼ is used for both weight w₁ⱼ and w₂ⱼ (so that dispersion serves as weight) and RNⱼ is used for the exceptionality measure mⱼ. When aggregating DCLevel nodes, M_{τ}_{ⱼ} is defined as:

$${M}_{{τ}_{j}} = {R}_{{τ}_{i}}^{N} = {\sum }_{j ∈ {L}_{i}} {w}_{1 j} \cdot {R}_{j}^{N} / {\sum }_{j ∈ {L}_{i}} {w}_{1 j} = {\sum }_{j ∈ {L}_{i}} {sR}_{j} \cdot {R}_{j}^{N} \cdot {\sum }_{j ∈ {L}_{i}} {sR}_{j} = {\sum }_{j ∈ {L}_{i}} ( {sR}_{j} \cdot \frac{{uR}_{j}}{{sR}_{j}} ) / {\sum }_{j ∈ {L}_{i}} {sR}_{j} = {\sum }_{j ∈ {L}_{i}} {uR}_{j} / {\sum }_{j ∈ {L}_{i}} {sR}_{j}$$

Thus,

$${M}_{{τ}_{i}} = {R}_{{τ}_{i}}^{N} = \{ \begin{matrix}{\sum }_{j ∈ {L}_{i}} ( {w}_{j} \cdot \frac{{uR}_{j}}{{sR}_{j}} ) / {\sum }_{j ∈ {L}_{i}} {w}_{1 j} = {\sum }_{j ∈ {L}_{i}} {uR}_{j} / {\sum }_{j ∈ {L}_{i}} {uR}_{j} & if i = DCLevel + 1 or base level is DCLevel \\ {\sum }_{j ∈ {K}_{i}} {w}_{2 j} \cdot {M}_{{τ}_{j}} / {\sum }_{j ∈ {K}_{i}} {w}_{2 j} = {\sum }_{j ∈ {K}_{i}} sRj \cdot {M}_{{τ}_{j}} / {\sum }_{j ∈ {K}_{i}} {sR}_{j} & if base level \neq DCLevel and i > DCLevel + 1\end{matrix}$$

In this embodiment, it is preferable to aggregate sRᵢ,

$${sR}_{i} = {\sum }_{j ∈ {K}_{i}} {sR}_{j}$$

in order to obtain the same scores for any dimensional decomposition of node i, when computing from immediate children, but this might not represent the best weighting. Alternatively, while more computationally expensive, sRᵢ may be directly computed on node I, in which case the final M_{τ}_{ᵢ} score should be a function of all M_{τ}_{ᵢ} scores obtained for all dimensional decomposition d under i.

In a preferred embodiment,

$${\sum }_{j ∈ {L}_{i}} {sR}_{j}$$

is replaced with a better term, as this term might not be the best estimate for the dispersion of node i. Usually the dispersion of the sum is not the sum of the dispersions, unless the time-series of all the leaves in Lᵢ have a pair-wise correlation of 1 (in which case

$${sR}_{i} = {\sum }_{j ∈ {L}_{i}} {sR}_{j} ) .$$

When some of the leaves have negative correlation with other leaves, sRᵢ might even be smaller than the sum

$${\sum }_{j ∈ {L}_{i}} {sR}_{j} .$$

As the variance of the sum is the sum of variances, when the leaves are completely uncorrelated

$${sR}_{i} \approx \sqrt{{\sum }_{j ∈ {L}_{i}} {( {sR}_{j} )}^{2}} .$$

Thus, an estimate to sRᵢ, which is better than

$$s {τ}_{i} = \sqrt{γ \cdot {( {\sum }_{j ∈ {L}_{i}} {sR}_{j} )}^{2} + ( 1 - γ ) \cdot {\sum }_{j ∈ {L}_{i}} {( {sR}_{j} )}^{2}} ,$$

is

$${\sum }_{j ∈ {L}_{i}} {sR}_{j} ,$$

where γ is a measure of a pair-wise correlation between the leaves, derived from the data. γ can be calculated either directly from leaf correlations, or calculated from its role—finding a γ value that minimizes the differences between sτᵢ and sRᵢ. Since γ is derived from the data, it may have different values in different parts of the cube. The terms

$${\sum }_{j ∈ {L}_{i}} {( {sR}_{j} )}^{2}$$

should be aggregated so that the modified dispersion measure may be used below.

In this case, the modified M_{τ}_{ᵢ} computation is:

$${M}_{{τ}_{i}} = {cR}_{{τ}_{i}}^{N} = \{ \begin{matrix}{\sum }_{j ∈ {L}_{i}} ( {w}_{1 j} \cdot \frac{{uR}_{j}}{{sR}_{j}} ) / {\sum }_{j ∈ {L}_{i}} {w}_{1 j} = {\sum }_{j ∈ {L}_{i}} {uR}_{j} / s {τ}_{i} \\ if i = DCLevel + 1 or base level is DCLevel \\ {\sum }_{j ∈ {K}_{i}} {w}_{2 j} \cdot {M}_{{τ}_{j}} / {\sum }_{j ∈ {K}_{i}} {w}_{2 j} = {\sum }_{j ∈ {K}_{i}} {sR}_{j} \cdot {M}_{{τ}_{j}} / s {τ}_{i} \\ if base level \neq DCLevel and i > DCLevel + 1\end{matrix}$$

While M_{τ} indicates the exceptionality for higher level nodes, a certain level of adjustable inaccuracy may be present, as M_{τ} does not leverage historical data. Furthermore, it may not be distributed evenly on the (0,1) range. When necessary, in order to improve the coefficient quality, an adjustment procedure may be applied. As an example of such a procedure, an adjusted node score Pm_{τ}, the percentile of M_{τ}, can be found using the order statistics of M_{τ}.

### Second Embodiment—Homogeneity Analysis

As parent nodes in one level, by the very nature of the multidimensional cube, contain aggregations of nodes in lower levels, a given phenomenon may often manifest itself through multiple descendent nodes, due to the contribution of exceptionality of an event occurring on the parent node to its descendents. The interaction of the parent nodes with its children, and through them with other descendent nodes, is considered a prime interaction.

This embodiment of invention uses the analysis of this prime interaction in order to identify the minimal number of nodes that best represent the events. Effectively, this means identifying the event manifestation(s) that best represent(s) the sources of the phenomenon. Such manifestations are the focal points of occurrences of events. One approach for analyzing the parent-descendents interaction makes use of homogeneity—a criterion that assesses the extent to which a phenomenon is manifested on child nodes of a given node in a similar manner, across all dimensional decompositions of that given node. In other words, a common behavior is observed on child nodes, as defined below.

It is assumed that the higher the homogeneity of the event manifestation across children of a given parent node, the lower the probability that the event occurred on the child nodes independently of the parent node (that is the higher the probability that the event actually occurred on the parent node), and vice versa. High homogeneity indicates the event originated in the environment represented by the coordinates of the parent node, rather than in any of the sub-environments represented by the child nodes.

Common behavior in children nodes can appear in two different ways:
A “sufficient” number of children are event or near-event suspects “supporting” the parent event suspect.
   A child is defined as supporting the parent if it is a near-exceptional node, that is, it has an exceptionality value that is higher than a threshold which is weaker than that required for an exceptional node, and its exceptionality is in the direction of the parent.
   The larger the aggregate measure volume of supporting children, and the more exceptional the supporting children are, the smaller the number of supporting children required to make it sufficient for declaring common behavior.
   However, no single child or small group of children may be responsible for most of the changes in the parent, i.e. removing any small group of children may not eliminate or radically decrease the exceptionality in the virtual parent node created by removing these children.
Very few small-sized children are exceptional or near-exceptional nodes, such that the exceptionality in the parent could not have been created by the exceptionalities in these children. An extreme case happens when none of children is exceptional (not even being near-exceptional). In this case the exceptionality in the parent is a combination of many non-exceptional children nodes in the same direction.

A parent node is preferably be determined as homogenous with respect to its children across all dimensional decompositions under it in order to be defined as homogenous and thus as a focal point candidate.

A leaf in the cube has no children in any dimension and is always considered homogenous. If a node has only one child in any of the dimensional decompositions, “common behavior” over the only child can be defined to exist or not, since the parent and child are in this case essentially just a different “name” for the same set of nodes.

Homogeneity is only determined for aggregate nodes which are exceptional. In a preferred embodiment, exceptionality strength scores, (computed directly through residual percentiles, normalized residuals, or estimated by MT or Pmr, as defined above), are used to decide on a degree of homogeneity. However, other scoring schemes may be used. When there are more than one homogenous nodes along any cube path, a decision is made for each one of them if it is an actual focal. For instance, we can keep only the top most homogenous nodes in each path, as well as contained (descendent) homogenous nodes that are more exceptional than their ancestor homogenous nodes by at least some predetermined degree.

Note that while the description above and below outlines a sequential processing order, where focal point analysis is done after cube exceptionality analysis is completed for the whole cube, this is just one possibility. In fact, both may interleave, defining sub-cubes as units of computation.

This algorithm may be used as the sole algorithm for focal point detection, and its output set of exceptional nodes may be regarded as the final sets of focal points. However, this algorithm may also be used together with other algorithms carrying out a global focal point analysis. In this final decision as per the correct set of focal points among those identified here, is done based on the outcome of the global analysis. The output set of the homogeneity analysis serves, in this case, as the input set for that global analysis, having the role of narrowing down the target focal point suspect population, thus improving the feasibility of the more heavy-duty computations, required by global analysis.

There are several techniques for computing homogeneity measures and two or more such techniques may be used concurrently. In order to incorporate two or more computed homogeneity scores into a single measure, a weighted homogeneity score across all of them could be defined. Regardless of the homogeneity technique used, homogeneity computations should preferably be done on all possible dimensional breakdowns of a particular node. The final homogeneity score for a particular node will be a function of the homogeneity scores for the various breakdowns. Such a function is, for instance, the minimum of those scores.

According to the first technique of this method, in order for a parent node to be regarded as being homogenous in its children, it is required that there be no “small” set of children that is responsible for the parent exceptionality. A small set of supporting children s, by itself, is not responsible for the exceptionality level of the parent if either one of the following is true: (1) the parent exceptionality score is not significantly decreased when recomputed without the set s of supporting children, for any dimensional decomposition; (2) if the parent exceptionality score is significantly reduced when recomputed without the set s of supporting children, the parent exceptionality is also reduced to a substantial degree when recomputed without all supporting children not in s, for any dimensional decomposition.

This technique is preferably used as complementary to other techniques, such as the binomial test described below.

The technique may be used in two cases:

(1) An exceptional parent node is assumed to be homogenous with a large enough number of supporting children, and it is required to verify that it is indeed homogenous, that is, there is no single supporting child or small set of supporting children that contribute a significant portion of the parent exceptionality.

(2). An exceptional parent has very few supporting children, and it is required to verify that the set of all supporting children does not contribute a large portion of the parent exceptionality. If it does, the parent is not homogenous. If it does not, the parent exceptionality is mostly attributed to the influence of all non-supporting children, making the parent homogenous.

Both cases are elaborated below.

In case (1), if a set of children supporting the exceptionality in the parent is found, it is desired to make sure that there does not exists a subset s of size at most k of the supporting children that contributes most of the exceptionality of the parent.

An “estimated child removal impact function” f is defined and used to define the estimated impact Mi on the parent exceptionality to occur if the child i is removed. The function f may be in the form of f (child exceptionality strength, child exceptionality size, parent exceptionality strength, parent exceptionality size). All supporting children are then arranged in descending order of M. Another “estimated subset removal impact function” g is defined and used to define an estimated impact SMᵢ on the parent exceptionality to occur if subset sᵢ of s with at most k supporting children is removed. The function g estimates the aggregate impact of removing k children on the parent exceptionality, and may be in the form of g(M₁ M₂, . . . , Mₖ). All subsets sᵢ of size k of supporting children are arranged in descending order of SMᵢ.

Each of the subsets sᵢ of at most k children, is removed one at a time, in the order defined above, and stop when stopping conditions are met as defined below.

For each exceptional parent node j, and for each subset s_{j,i} (a subset of the supporting children of node j that are in sᵢ) until stopping conditions are met, a “virtual node” is created representing parent j after s_{j,i} are removed, identified as VParentj.
Volume of VParentⱼ(t) Volume in parentⱼ(t)−aggregate volume in s_{j,i}(t)

The subtraction is done on the measure values for all t in the parent node history or defined time window. New exceptionality scores are then calculated for the new node VParentⱼ, using the same scoring scheme originally used to score the nodes.

Note that when the analysis is done on a derived measure, these computations may have to be done for multiple measures. For instance, if the target measure is market share, which is defined as the ratio of sales of company x and the total sales of all companies, the computation is done for both and then the first is divided by the second, to get the market share value for VParentⱼ node.

In a similar way another virtual node, VParent2ⱼ, can be calculated for each parent node j, representing parent j after removing all supporting children of j which are not in s_{j,i}. If q_{j,i} are all supporting children of parent j less those that are in s_{j,i}, Volume of VParent2ⱼ(t)=Volume in parentsⱼ(t)−aggregate volume of q_{j,i}(t)

Note that both sets of computations are done for any dimensional decomposition under parent j.

The parent node is considered homogenous if there is no dimensional decomposition under the parent, and there is no subset s_{j,i} for which the difference in the exceptionality strength of the parent j and VParentⱼ is significant, and the difference in exceptionality strength of the parent j and VParent2ⱼ is insignificant. The process is carried out iteratively through the sequence of s_{j,i} subsets in decreasing order of M, and stopping as soon as the first subset s_{j,i} and dimensional decomposition are found for which the differences in exceptionalities as defined above do not meet the conditions, rendering the parent non-homogenous.

Note that it is not enough for the removed children to be significant in their influence over the parent for deciding that the parent is not homogenous. It is also required that the other supporting children be insignificant in their influence over the parent for making this decision. For instance, if there are two large enough children in a node (representing a big enough portion of the aggregate children volume), removing either one of them can influence the parent very much. If one is in s_{j,i} (k=1), removing it impacts the parent significantly, but the remaining child has a strong enough impact on the parent too, and thus the parent may be regarded as being homogenous, as 2 large enough children support the parent.

The threshold for a significant change can be a predefined percentage, or a number of standard deviations over the exceptionality measure distribution. It can also be based on the relative size of supporting children.

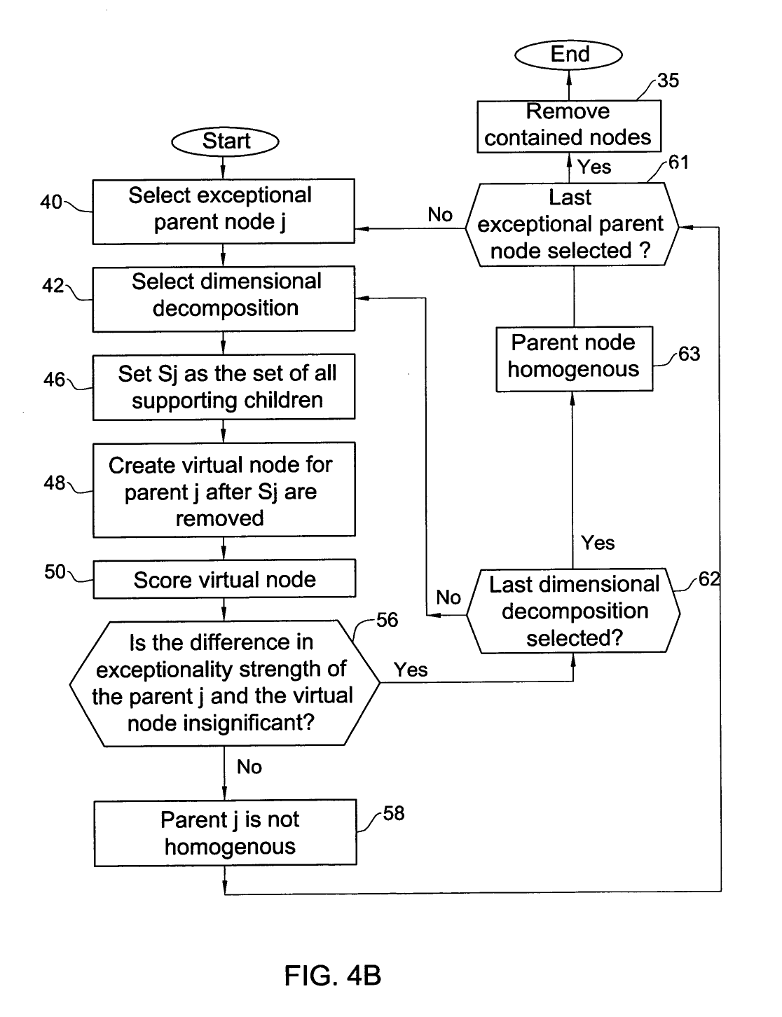

FIG. 4a shows a flow chart for carrying out the first technique for case 1. In step 10 an exceptional parent node is selected, and in step 12 a dimensional decomposition is selected. In step 14, the subsets Sⱼᵢ of size k of supporting children are arranged in decreasing order of impact SM=g(Sᵢᵢ) on the parent if the set were to be deleted. In step 16, the set Sⱼᵢ having the largest impact is selected. In step 18, a first virtual node is created by removing the nodes of Sⱼᵢ, and in step 20 the first virtual node is scored. Then, in step 22, a second virtual node is created representing parent j after removing all supporting children that are not in Sⱼᵢ, and in step 24, the second virtual node is scored. In step 26 it is determined whether the difference in exceptionality of the parent j and the first virtual node is significant and the difference of the exceptionality of the parent and the second virtual node is not significant. If no, then in step 28 it is determined whether the last Sij has been selected. If no, the Sⱼᵢ having the next largest SM is selected in step 30, and the process returns to step 18. If yes, then in step 32 it is determined whether the last dimensional decomposition has been selected. If No, then the process returns to step 12 with the selection of the next dimensional decomposition. If at step 32 it is determined that the last dimensional decomposition has been selected, then in step 34 it is determined whether the last exceptional parent node has been selected. If no, the process returns to step 10 with the selection of the next exceptional parent node. Otherwise, in step 35 contained nodes are removed and the process terminates.

If at step 26 it was determined that the difference in exceptionality of the parent j and the first virtual node is significant and the difference of the exceptionality of the parent and the second virtual node is not significant, then in step 36 it is concluded that the parent node is not homogeneous. If the parent node is not the last parent node (step 38), then the process returns to step 10 with the selection of the next exceptional parent node. Otherwise the process terminates.

In case (2), if there are very few children supporting the parent exceptionality and these few supporting children make most of the exceptionality in the parent, the parent is not homogenous. However, if they do not, the exceptionality in the parent is derived from the non-supporting children of the parent, and the parent is homogenous in the non-supporting children. Thus we want to make sure that the set of all supporting children s does not contribute a significant portion of the parent exceptionality, by removing all of them at once and verifying the parent exceptionality does not change much.

For each exceptional parent node j, a “virtual node” is created representing parent j after the sⱼ are removed, identified as VParentⱼ.
Volume of VParentⱼ(t)=Volume in parentⱼ(t)−aggregate volume of children in sⱼ(t)

When dealing with derived measures the note made above applies here as well. New exceptionality scores are now calculated for the new node VParentⱼ. This is computed for each dimensional decomposition under the parent.

The parent node j is considered to be homogenous if, for all dimensional decompositions under the parent j, the difference in the exceptionality strength of the parent j and VParentⱼ is insignificant. This means that the exceptionality in the parent j is attributed mostly to the non-supporting children, which, while not exceptional by themselves, were subject to interference phenomena which caused the exceptionality on the parent.

FIG. 4b shows a flow chart for carrying out the first technique of this embodiment for case 2. In step 40 an exceptional parent node is selected, and in step 42 a dimensional decomposition is selected. In step 44, the subset Sⱼᵢ of all supporting children is selected. In step 48, a virtual node is created by removing the nodes of Sⱼ, and in step 50 the virtual node is scored. Then, in step 56 it is determined whether the difference in exceptionality of the parent j and the virtual node is insignificant. If no, then in step 58 it is concluded that the node j is not homogeneous, and then in step 34 it is determined whether the last parent node has been selected. If no, the process returns to step 40 with the selection of another exceptional parent j. If yes, then in step 35, all contained nodes are removed and the process terminates.

If at step 56 it was determined that the difference in exceptionality of the parent j and the virtual node is insignificant, then the process continues with step 62 where it is determined whether the last dimensional decomposition has been selected. If no, the process returns to step 42 with the selection of the next dimensional decomposition. If yes, then in step 63 it is concluded that the parent node is homogeneous, and the process continues with step 34.

In the second technique of this method, the following statistical null hypothesis is used:

H₀: Exceptions of the children have occurred independently of one another.

H₀is accepted when the probability that that many of children pass the parent support threshold independently of one another is high enough. Conversely, rejecting this assumption means that it is very probable the supporting children have not become that exceptional independently. That is, the children exhibit some common exceptionality behavior which is assumed to be driven by the dependency of these children on their parent. In other words, this means the parent is homogenous. H₀ has to be rejected across all dimensional decompositions in order to declare that the parent node is homogenous.

This test deals with both the quantity and volume aspects of homogeneity. It is not sufficient to say, for example, that 80% of the measure volume under the parent supports the parent exceptionality for declaring the parent as homogenous. The number of children to which supporting volume is allocated matters too, as there is a big difference between a case where, for instance, one of fifty children supports and has the majority of that volume, and a case where that volume is allocated to 10 supporting children. While the base test is quantity focused, it involves volume-based elements, as described below.

The following first describes the base test employed, after which enhancements are described.

Exceptionality in a child may be thought of as a Bernoulli experiment with constant probability of “success” (that is, the child node has sufficient exceptionality in it to render it as a supporting node). For each child i, an indicator random variable Xᵢ is defined to be equal to 1 if the child's residual percentile is bigger than the supporting exceptionality threshold percentile p (0≦p≦1). Under H₀, the Xᵢ are independent random variables and

$${\sum }_{i = 1}^{n} Xi \approx Bin ( n , 1 - p )$$

where n is the number of children in the dimensional decomposition under consideration; 1-p is the “success” probability of each experiment and Bin(n,1-p) is the binomial distribution. If k is the number of Bernoulli experiment successes (the number of the supporting children). Let

$$X = {\sum }_{i} {X}_{i} .$$

H₀ is rejected when P_{Bin(n,1-p)}(X≧k)<α, where α is a predetermined threshold.

Now that the base test has been described, a few enhancements may be introduced in order to meet the common behavior requirements defined above.

First, it is preferable to test the children for support over a set of m exceptionality levels p₁<p₂ . . . <pₘ as the probability of “success” in a single experiment, and then run the Binomial tests for each such pᵢ. This way the extent of exceptionality can be traded off with the number of supporting children. That is, the more exceptional supporting children there are, the fewer number of supporting children that would be required for rejection of H₀ (and declaring common behavior). If, for a particular k and p, H₀ is rejected, then, if, for the same k, the exceptionality barrier is increased (thus decreasing the probability for “success”) to p′, P_{Bin(n,p′)} (X≧k) will be smaller than P_{Bin(n,p)} (X≧k), thus allowing a reduction in k, the number of supporting children, while still rejecting H₀. Therefore, if at least one of these binomial tests is rejected, common behavior (homogeneity) is declared on the parent.

Second, instead of just doing a binomial test on the set of all children [1,2, . . . ,n], the children may be sorted in descending order of the smoothed measure value (obtained by running a moving average or another smoothing technique over the source measure values). Then, a set of tests on each Pareto subset: [1,2], [1,2,3], [1,2,3,4], . . . , [1,2, . . . ,n] (i.e. the two biggest children, three biggest children, etc.) is carried out.

This test is preferably done only on all subsets which have more than a certain percent of the volume of the parent and for which the supporting children in the subset contain at least a certain percent of the volume in the subset. If at least one of these binomial tests is rejected, common behavior (homogeneity) is declared.

This enhancement of the base test allows a tradeoff between the aggregate measure volume of supporting children and the number of supporting children. The larger the volume of supporting children, the less the quantity sufficient to declare common behavior, since “larger” children are tested in binomial tests using a smaller n and the same p. Furthermore, it would be difficult for children with very low volume (in comparison to the parent volume) to impact on the test result.

According to the third technique of this method the binomial test procedure just described uses exceptionality of children for determining homogeneity in the parent. According to the third technique of this method, the binomial test is carried out where exceptionality of a child is defined based on the ratio of exceptional leaves under that child to the total number of leaves under the child. n

In this case the child is defined as follows:

Defining Leaf Exceptionality

For each child node j of the tested parent, Leaves(j) is defined as the set of leaves, and n(j) is defined as the number of leaves, under child j. Each such leaf 1 is regarded as supporting the exceptionality of node j if 1 has near-exceptionality on it, that is, its exceptionality score (p(R) or RN in the preferred ways of scoring) exceeds a predefined exceptionality level p. An indicator I1 as 1 if leaf 1 is exceptional and 0 otherwise.

Defining rₑ Ratio

LS is defined as the number of all exceptional leaves under j, or

$${\sum }_{l ∈ Leaves ( j )} {I}_{l} .$$

For each child j we define the ratio

$$re = \frac{LS}{n ( j )}$$

Determining Child j's Exceptionality

Using a time window TW, an order statistic with historical re ratio values is computed for leaves under child j. pr is defined as an exceptionality percentile threshold, and child j is defined to be exceptional enough for supporting its parent, if the percentile of rₑ in the order statistics of child j is larger than pr.

The above procedure may be run for multiple p and pr values, for the same reason explained above. Once the set of supporting children has been determined, the binomial test is run as described above.

The leaf nodes, as used in the computations above, can be replaced with the nodes in a certain level higher than the leaf level. This may be of value when, for instance, there is insufficient historical data for some leaves. This will, however, requires the exceptionality score to be a function of all scores obtained through the various dimensional decompositions under child j

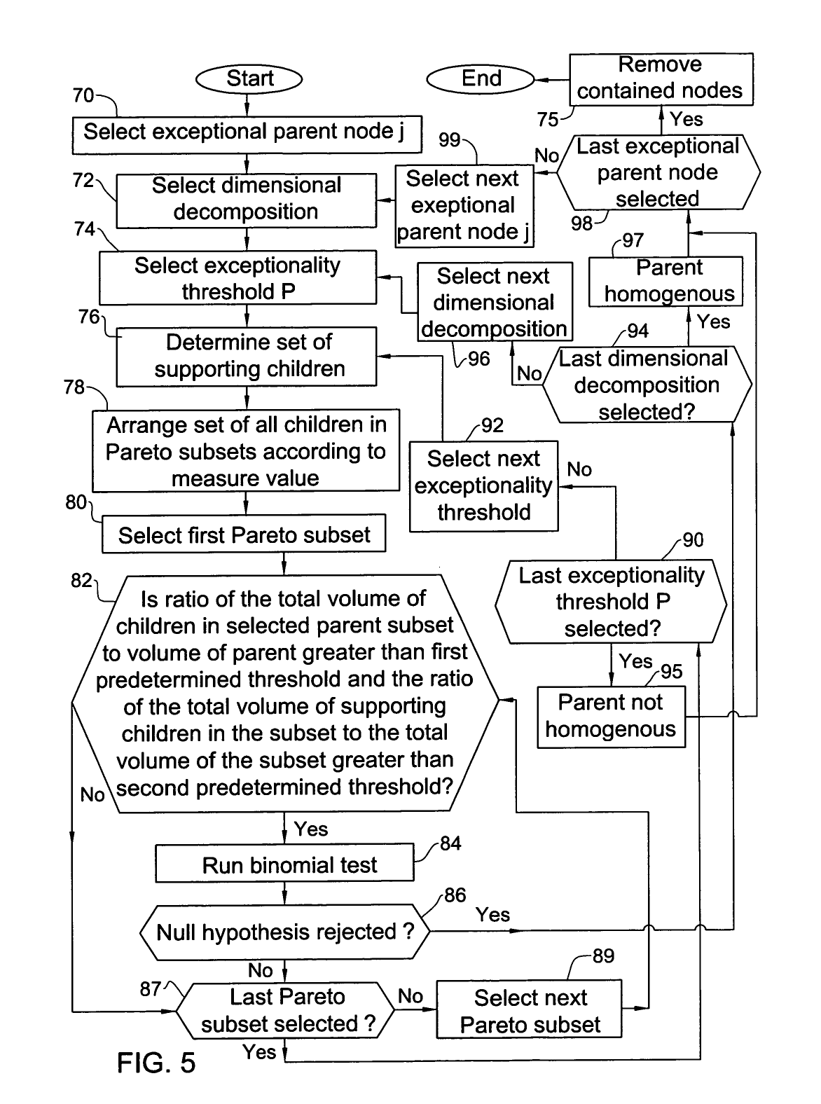

FIG. 5 shows a flow chart for carrying out the third technique of this embodiment of the invention. In step 70, an exceptional parent node is select, in step 72 a dimensional decomposition is selected, and in step 74 an exceptionality threshold p is selected. Instep 76 the set of supporting children is determined. The set of all children of the parent are then arranged in Pareto subsets according to their measure value (step 78). In step 80, the first Pareto subset is selected and then in step 82 it is determined whether the ratio of children in the Pareto subset to the volume of the parent is greater than a first predetermined threshold and the ratio of the total volume of the supporting children to the total volume of the subset is greater than a second predetermined threshold. If yes, then in step 84 a binomial test is run and in step 86 it is determined whether the null hypothesis is rejected.

If at step 86 the null hypothesis is not rejected, then in step 87 it is concluded that the parent is homogeneous in this dimension and the process continues to step 87 where it is determined whether the last Pareto subset has been selected. If no, then at step 89 the next Pareto subset is selected and the process returns to step 82. If the last Pareto subset has been selected, then the process continues to step 90 where it is determined whether the last exceptionality threshold has been selected. If no, then the process continues to step 92 with the selection of the next exceptionality threshold and the process returns to step 76.

If at step 90 it is determined that the last exceptionality threshold has been selected then in step 95, the parent is declared not homogeneous and the process continues to step 98 In step 98 it is determined whether the last exceptional parent has been selected. If yes, the the process continues to step 87 where the parent node is delcalred homogeneous, and the process continues to step 98. if no, then in step 96, the next dimensional decomposition is selected and the process returns to step 74. If yes, then in step 98 it is determined whether the last exceptional parent has been selected. If no, then instep 99 the next exceptional parent is selected and the process returns to step 72. Otherwise, contained nodes are removed (step 75) and the process terminates.

If at step 86 the null hypothesis is rejected, then in step 88 it is determined that the parent is not homogenous and the process continues at step 87.

According to the fourth technique of this method, it is observed that the higher the homogeneity, the higher the extent of spread of exceptionality in children, and vice versa. In essence, the smaller the portion of the parent residual explained by the larger portion of parent volume, the lower the exceptionality explained by that volume portion, and the more is exceptionality concentrated in a smaller subset of volume, thus the lower the homogeneity is.

The ratio of the residual of a child i to the residual of the parent is denoted as RPᵢ; The ratio of the volume of a child to the volume of the parent is denoted as VPᵢ. RPᵢ may be regarded as a limited resource “allocated” to parent volume. As such, RPᵢ is expected to comply with the Pareto distribution.

VPᵢ may be viewed as the “probability” that a unit of volume is associated with (has participated in contributing to) a certain residual proportion.

When looking at the cumulative Pareto distribution function, the volume proportion explaining a cumulative proportion of the residuals smaller than or equal to a certain proportion is obtained. That is, the cumulative probability that a unit of volume is associated with (has participated in contributing to) a certain cumulative residual proportion, is provided.

As the residual proportion random variable is bounded by 1, the Truncated Pareto distribution, rather than the standard Pareto distribution, must be employed.

VP_{i,d,j} is defined as the explaining volume portion for each child j of parent i under dimensional decomposition d. It is computed for all children in the subset S_{i,d} of children of which the residual is in the same direction as that of the parent i and for all dimensional decompositions under i. RP_{i,d,j} is defined similarly. The RP values are then ordered by ascending order, where RP_{i,d,j}^{(k)} denotes the k largest RPP value.

Note that both RP and VP are computed based on the aggregated values of R and V. R and V are aggregated from the leaves or recursively from children having the same residual sign as that of the parent node.

The truncated cumulative distribution function is given by:

$${F}_{RP} ( rp ) = P ( RP <= rp ) = \frac{1 - {( \frac{b}{rp} )}^{a}}{1 - {( \frac{b}{c} )}^{a}} , \qquad c > b > 0 , a > 0$$

Where a is the power parameter, b is the left bound (which is set to 0 in this case), and c is the right bound (which is set to 1).

The larger a, the larger the cumulative probability that a certain cumulative residual proportion will be explained by a larger volume proportion. That is, the larger a, the smaller the residual proportion that is explained by the larger volume portion, and thus the smaller is the exceptionality manifested on the larger portion of the volume, and the smaller the parent homogeneity. The homogeneity score h_{i,d} can thus be defined, for example, as 1/a. The final homogeneity score of parent i will be a function of all h_{i,d}, typically the minimum. The scores are computed separately for positive and negative exceptionality

Given the data pairs RPᵢ, VPᵢ, a may be estimated using a Maximum Likelihood Estimator (MLE). For example, as disclosed in Inmaculada B. Aban, Mark M. Meerschaert, and Anna K. Panorska “Parameter Estimation for the Truncated Pareto Distribution”, (this publication may be obtained at http://www.maths.otago.ac.nz/˜mcubed/TPareto.pdf) the MLE â is the â that solves:

$$\frac{n}{\hat{a}} + \frac{{n [ {RP}_{( n )} / {RP}_{( 1 )} ]}^{\hat{a}} ln [ {RP}_{( n )} / {RP}_{( 1 )} ]}{1 - {[ {RP}_{( n )} / {RP}_{( 1 )} ]}^{\hat{a}}} - {\sum }_{i = 1}^{n} [ ln {RP}_{( i )} - ln {RP}_{( n )} ] = 0$$

where RP₍₁₎ RP₍₂₎≧ . . . RP₍ₙ₎ is the order statistics of the RP “samples”. We can solve this equation for a numerically, by using methods such as Newton-Raphson.

It is possible also to verify the quality of a by conducting a goodness of fit test, determining to what extent does the data is Pareto distributed, for example based on the Kolmogorov-Smirnov test.

The procedure described above is defined for computing the parent homogeneity coefficient from its immediate children. Similar solution may be defined also for computation from the leaves.

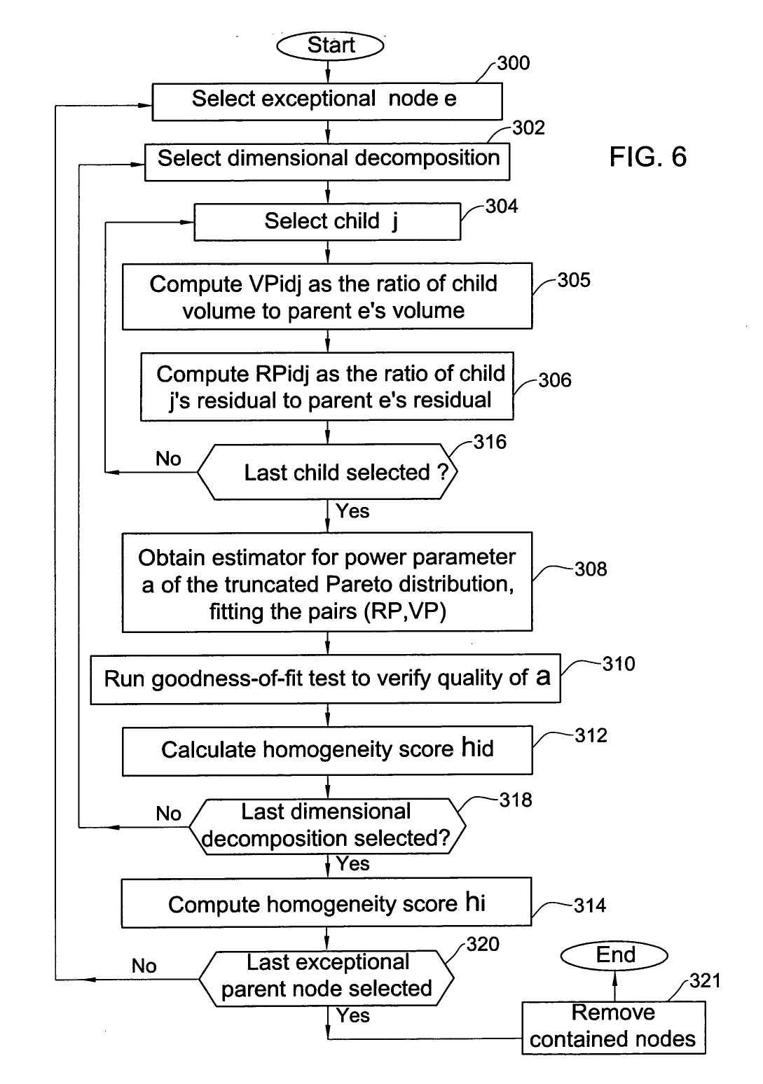

FIG. 6 shows a flow chart for carrying out the fourth technique of this embodiment. In step 300 an exceptional parent is select, and in step 302 a dimensional decomposition is selected. In step 304 a child j of the selected parent is selected. In step 305, VP_{idj} is calculated as the ration of child j's volume to parent e's volume, and in step 306, RP_{idj} is calculated as the ratio of child j's residual to parent e's residual. The process then continues to step 316, where it is determined whether the last child of he selected parent ahs been selected. If no, then the process returns to step 304 with the selection of the next child. Otherwise the process continues to step 308 In step 308, a likelihood estimator for the power parameter a of the truncated Pareto distribution fitting the pairs (RP, VP) is obtained, for example, as disclosed in Aban et al (supra). A goodness-of-fit test is then run to verify the quality of a (step 310), and then the homogeneity score h_{id} (step 312) is calculated. The process then continues to step 318 where it is determined whether the last dimensional decomposition has been selected. If no, the process returns to step 302 with the selection of the next dimensional decomposition. Otherwise the process continues with step 314 where the homogeneity score hᵢ (step 314) is calculated.

The process now continues with step 320 where it is determined whether the last exceptional decomposition has been selected. If no, the process returns to step 300 with the selection of the next exceptional parent node. Otherwise contained nodes are removed (step 321) and the process terminates.

According to the fifth technique of this method it is assumed, in order to explain the technique, that all children of a parent are removed and ordered in list 1 with descending order of exceptionality. Children are now added back one by one in decreasing order of their exceptionality, as long as they keep adding marginal exceptionality contribution to the parent exceptionality. The number of children that can added before the marginal contribution goes negative is an indication to the extent of support of children in the parent, and can be is used as a measure of homogeneity.

A child is added one at a time, and after adding each child two probabilities are calculated, assuming independence of the children: (1) the probability that the resulting joint phenomenon (all children having the computed exceptionality on them) occurred and (2) the probability that the joint phenomenon did not occur. Both probabilities are based on historical data.

For example, it is assumed that three most exceptional children have residual percentiles of 0.95, 0.9, and 0.85. When adding the first child, the probability the phenomenon would occur is 0.95, and the probability it would not occur is 0.05. After adding the second child, the probability the joint phenomenon would occur is 0.95*0.9=0.855, and the probability the joint phenomenon would not occur is 1−0.855=0.145. After adding the third child, the probability the joint phenomenon would occur is 0.95*0.9*0.85=0.72675, and the probability the joint phenomenon would not occur is 1−0.72675=0.27325. As seen above, the gap in probabilities is shrinking. As long as the probability that the joint phenomena occurred is larger than the probability it did not occur, the added child contributes to the parent exceptionality. If, when adding the m-th child, the joint probably that the exceptionality on all the included children did not occur becomes larger than the probability that exceptionality on all those children did occur, then the added child, as well as any of remaining children, do not add a marginal contribution to the parent exceptionality.

The above discussion assumes independence of the children. When the independence assumption does not hold, the joint phenomenon probabilities are higher, causing the point of convergence to occur after more children than otherwise, thus making the homogeneity score higher, as seen below. This is in line with the way lack of children independence is interpreted, in the context of the homogeneity problem, as dependency of the children on the parent.

Child exceptionality may be defined similarly to that described above in the third technique (binomial homogeneity test variation). The percentile

$$P ( {r}_{{e}_{i , j , d}} )$$

is used to indicate exceptionality of a child j under parent i, where rₑ=

$${r}_{{e}_{i , j , d}} = \frac{{LS}_{i , j , d}}{{n}_{i , j , d}} ,$$

where LS_{i,j,d} is defined as the number of all exceptional leaves under child j of parent i, and n_{i,j,d} is defined as the number of leaves under child j of parent i, all in the dimensional decomposition d.

The homogeneity degree h of parent i under dimensional decomposition d is defined as:

$$\begin{matrix}{h}_{i , d} = max \frac{m}{\vert {Children}_{i , d} \vert} \\ s . t . 1 - {\prod }_{j = 1}^{m} P ( \frac{{r}_{{e}_{i , j , d}}}{{n}_{i , j , d}} ) < {\prod }_{j = 1}^{m} P ( \frac{{r}_{{e}_{i , j , d}}}{{n}_{i , j , d}} )\end{matrix}$$

Where:

Children_{i,d}—The number of immediate children of node i according to dimensional decomposition d, and j runs from 1 to size of list 1 in descending order of exceptionality. The m-th child is the first child which is not contributing to the parent exceptionality when added.

In order to be more conservative in deciding on m the formulation above may be changed to:

$$\begin{matrix}{h}_{i , d} = max \frac{m}{\vert {Children}_{i , d} \vert} \\ s . t . 1 - {\prod }_{j = 1}^{m} P ( \frac{{r}_{{e}_{i , j , d}}}{{n}_{i , j , d}} ) < {( P ( \frac{{r}_{{e}_{i , j , d}}}{{n}_{i , j , d}} ) )}^{m}\end{matrix}$$

This will cause convergence to happen earlier.

The total homogeneity score for node i is defined as:

$${h}_{i} = {min}_{d} {h}_{i , d}$$

According to the sixth technique of this method, the alternatives described above may be used to complement one another in various ways for getting better homogeneity decisions. Homogeneity involves various aspects, such as quantity and volume, as no test addresses all aspects the same. In one preferred embodiment, the invention runs the following procedure for each exceptional node:
If the node is a leaf, the node is homogenous
If the node has only one child in any of its dimensional decompositions, the node is not homogenous
For every dimensional decomposition d for which the parent node has children under it:
   If there are no supporting children in dimension d (in any support level), the node is homogenous;
   The binomial test as defined above is carried out on parent node for the dimensional decomposition d under the parent
   If the binomial result is TRUE
      If exceptionality is changed significantly when removing a small set of supporting children and insignificantly when removing the remaining supporting children, for testing for homogeneity in supporting children as defined above the node is not homogenous
   Else if binomial result is FALSE
      If exceptionality is changed significantly when removing all supporting children, for testing for homogeneity in non-supporting children as defined above the node is not homogenous
   Else the node is homogenous
   If there are multiple homogenous nodes along any single cube path, a decision rule determining the final set of focal points may be applied. One such rule may be, for example, keeping only the topmost homogenous node in any path, as all other homogenous nodes are descendent of that node. A second such rule may be keeping, in addition, descendents (contained) homogenous nodes that are more exceptional than their ancestor (containing) homogenous nodes.

The Homogeneity principle is applicable, and its test may be extended to apply, for wider context than children. For example, it is applicable also for identifying subgroups of children which exhibit a common exceptionality behavior differing from that of the rest the children. This situation is indicative of a missing dimension, where all children in such a subgroup would have had the same coordinate of that missing dimension. A missing parent would have thus been determined to be homogenous in the children of this subgroup, even if the current parent of the set of children this subgroup belongs to is determined as non-homogenous. As another example, parent homogeneity may be checked with respect to leaves as well as other descendent levels too, not only to children.

### Third Embodiment—Coarse Algorithm

In this embodiment, an algorithm, referred to herein as “the coarse algorithm”, is applied to pairs of exceptional node e and set of exceptional nodes N for which e*N≠Ø. For each such pair the exceptionality in the set e*N may be thought of as attributed to either e or N, but not to both. For each exceptional node e, and for each subset of exceptional nodes N, the leaves in e*N are removed from the data set. Node e after the removal, named e′, is now left with only the leaves in e\N. e′ is rescored using he same scoring scheme that was originally used to score the dataset. It is expected, for any true focal point node e, given certain limits on the size of N, that there would be reasonable remaining exceptionality in e\N. A binary relation K(N,e) is defined where K(N,e) takes on the value “true” if e\N is not sufficiently exceptional, given its intersection with N. The node e is considered not to be a focal point if there exists N such that:
(a) N intersects with e such that K(N,e) is true; and
(b) For each n in N, and for each set X of nodes intersecting with n, K(X,n) is false; and
(c) The size of N satisfies a predetermined constraint requirement.

That is, a node e is filtered only if there is sufficient and undoubted evidence that e is not a true focal. Obviously, if (a) holds (providing evidence that e might not be a true focal point) but (b) does not, it is possible that the exceptionality of one or more nodes in N causing e\N's exceptionality to drop might itself be contributed by some other nodes. In this case N is not a reliable evidence for filtering out e.

The requirement (c) on the size of N prevents inappropriately identifying e as a non-focal point which might occur when a set N satisfying the requirements (a) and (b) is too large. This is because the larger N the greater the probability that N “covers” e completely, thus almost totally eliminating the exceptionality in e\N, making the test above weaker.

The constraint on the size of N may be defined by predetermining an upper limit of the size of N. It is preferred, though, to constrain N indirectly as follows. As described above in reference to the second embodiment, for each node e, e is determined to be homogenous if the probability that the exceptionality evident in its children occurs under the assumption that the children are independent, is low. The larger the number k of exceptional children under e, given a total number of children n and exception probability p, the higher the probability that e is determined to be homogenous. If e is homogenous, removing all of the exceptional children is expected to eliminate all of e's exceptionality. The intersection of N and e, N*e, is the union of intersections of N and all children c of e. If the set of nodes N*c makes e pass the homogeneity test, removing the nodes N*c from e is expected to eliminate e's exceptionality, and thus N is too large to be safely used in the above interaction-removal procedure.

More formally, given N, a subset of nodes intersecting with e, the intersection of N with each child c of e for each dimensional decomposition d in D (namely each c in set C_{d}) is checked. There are |D| sets each of maximal size |C_{d}| of intersections N*c. The subset of exceptional enough children c in C_{d} for each d, CE_{d}, for which the portion of volume and/or amount of leaves in N*c within c is larger than some predefined extent, is tested for homogeneity through the binomial test procedure described in the second embodiment. If the binomial test fails for all d's, e is homogenous in CE_{d}. This means that removing the set of children CE_{d} from e will always eliminate e's exceptionality, which in turn means that N may not be used to test the true value of K(N,e).

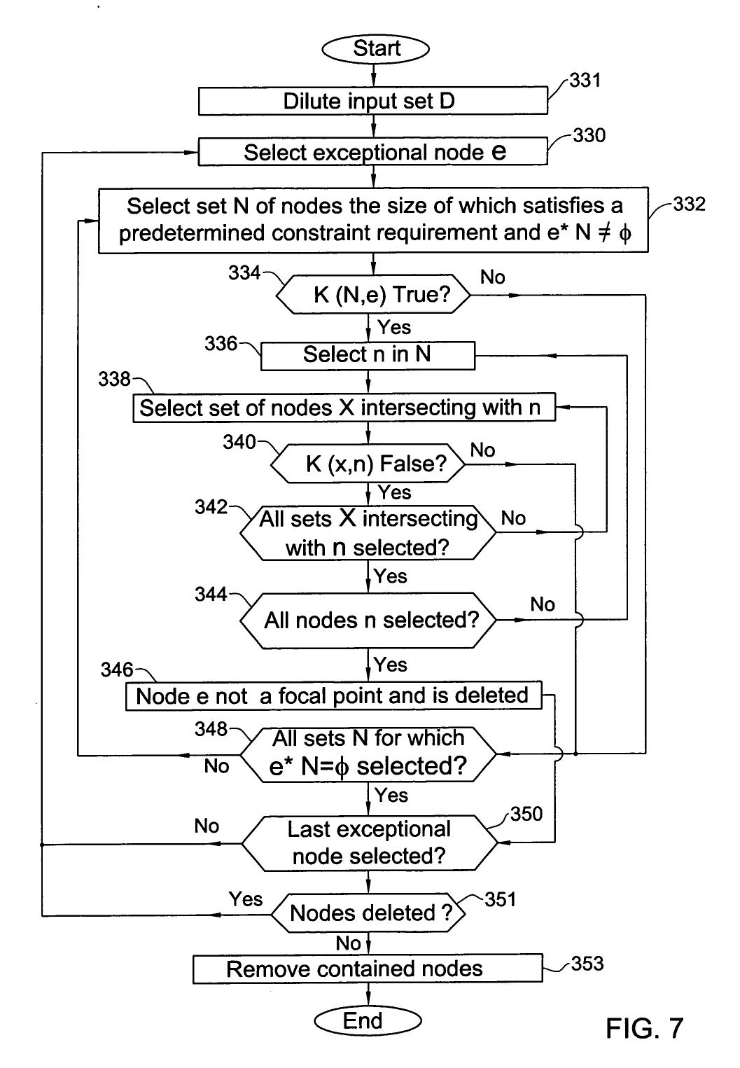

FIG. 7 shows a flow chart for carrying out this embodiment of the invention. In step 331, the input set is diluted and in step 330, an exceptional node e is selected. In step 332 a set N of nodes that satisfies a predetermined constraint on it size is selected for which e*N≠Φ. In step 334 it is determined whether K(N,e) is true. IF yes, then in step 336 a node n in N is selected, in step 338 a set X intersecting with n is selected and in step 340 it is determined whether K(X,n) is false. If yes, then in step 342 it is determined whether all sets X intersecting with n have been selected. If no, the process returns to step 338 with the selection of another set X. If in step 342 it is determined that all sets X intersecting with n have been selected, then in step 344 it is determined whether all nodes n have been selected. If no, the process returns to step 336 with the selection of another node n. If yes, then in step 346 it is concluded that e is not a focal point and the process continues with step 350 where it is determined whether the last exceptional node has been selected. If no, then the process returns to step 330 with the selection of another exceptional node. If yes the process continues to step 351 where it is determined whether nodes have been deleted. If no, contained nodes are removed (step 353), and the process terminates. If at step 351 it is determined that nodes have been deleted, the process returns to step 330.

If at step 334, it is determined that K(N,e) is not true, then the process proceeds to step 348 where it is determined whether all sets N for which e*N≠Φhave been selected. If no, then the process returns to step 332 with the selection of a new set N. If yes, then the process continues with step 350.

### Fourth Embodiment—Fine Algorithm

In this embodiment, an approximation of the exceptionality contributed by a set of nodes N to the exceptionality measured on node e, Cx(N,e), and exceptionality contributed by an event occurring on node e to e's measured exceptionality, Cx(e,e) are assessed and used to determine the set of focal point nodes.

First, in order to determine whether a set of nodes N interacts with e, a rank test (such as Wilcoxson) may be carried out testing whether the population of leaves in e\N and in e*N are the same. If the populations are deemed different, N is interacting with e. The fine algorithm is demonstrated for the case where N is positively interacting with e, thus contributing exceptionality to e. This implies that the exceptionality of e*N is higher than that of e. The algorithm may be illustrated also for the case where N negatively interacts with e, thus having negative exceptionality contribution to e.

Then, under the assumption (which is relaxed below) that all the exceptionality in e*N is induced by N, the exceptionality remaining in e after removing N's interaction is approximated by the exceptionality of e\N. The exceptionality of e\N, resulting from the set of leaves that are descendents of e but not of N, will be referred to as the “Unadjusted Minimal N-Reduced Exceptionality”, or UNRE(N,e). If I(e) denotes the largest set of nodes N intersecting with e, UNRE(N,e) approximates the combined exceptionality remaining on e, originating in both Cx(e,e) and the set of contributions Cx(n,e) for all n's in I(e)\N. It is seen below why it is problematic to compute UNRE for only N=I(e), thus assessing directly Cx(e,e), and techniques of compensation for this inexactness are provided.

Note that the UNRE approximation is an overestimation of the remaining exceptionality score of e. The removal of the leaves in e*N from e, instead of only reducing their exceptionality, may result with too small reduction in the exceptionality of e. This is because the exceptionality of e is some average of the exceptionalities of e*N and e\N, and without e*N, the diluting effect of the low exceptionality remaining on e*N will not take place.

The confidence in UNRE may decrease with the size of e\N, as the exceptionality of e\N is a random variable whose variance increases when, the size of e\N decreases. This is because the exceptionality of e\N may be viewed as some weighted average of the exceptionality random variables of the leaves, and as such the fewer the number of variables averaged the higher is the variance. In order to have confidence in the exceptionality of e\n it is desirable to take into account the possible reduction in accuracy due to the variance. This is taken into account by obtaining an Upper Confidence Limit (UCL) for UNRE(N,e). This may be achieved in several ways, one of which is to run successive tests where a random sample of leaves having a total measure volume similar to that of e*N is removed from the leaves of e, resulting in e′. e′/n is then rescored using the remaining leaves. The expected extent of deviation of the exceptionality of e′/N from that of e\N, U, is added to UNRE(N,e) to obtain the UCL, which is referred to as NRE(N,e), the (Adjusted Minimal) N-Reduced Exceptionality. Obviously, the UCL will tend to grow when the size of e\N decreases, thus compensating for the reduced strength of the test.

The assumption made above that all exceptionality in N*e is attributed to N is obviously not true in most cases, and is now relaxed. A function B(N,e) is defined which is a [0,1] score representing the belief that N*e's exceptionality is actually induced by e, rather than by n. That is, 1 represents the belief that e actually contributes all the exceptionality in e*N, and 0 represents the belief that N contributes all the exceptionality in e*N.

The belief score depends mainly on a comparison of the exceptionality of e*N with that of e and N. For example, if e*N is more exceptional than N, the belief may reach 1; but if e*N has exceptionality equal to the average of that of nodes in N and e, the belief score may equal 0.5. In addition, if homogeneity is computed for node e and nodes n in N, the relative extents of homogeneity of e and nodes n in N may impact the belief scores. The more homogenous node e is relative to nodes in N, the greater the belief that the exceptionality of e*N is contributed by e rather than N.

The Approximate N-Set Exceptionality Contribution NSEC(N,e), the approximation of the exceptionality contributed by N (Cx(N,e)), is now computed as: NSEC (N,e)=[X(e)−NRE(N,e)]*[1−B(N,e)]

NRE and NSEC scores may be derived for largest set of nodes N intersecting with e, namely I(e). However due to the approximation used, it may happen that the set of leaves contained in the union of nodes in I(e) fully includes the leaves contained in e. In this case UNRE(N,e) is either undefined (for zero leaves in e\N) or might be inadequate (for very small amount of leaves in e\N, resulting in very small UNRE(N,e), possibly too small, and very large NRE(N,e), possibly too large). In either case, this might make it impossible to obtain true estimates of the actual contribution of I(e) to e. An alternative is to calculate NSEC scores for all subsets of nodes in I(e) (given a certain constraint on the characteristics of the subsets, as defined below), and then to use these scores to get a better estimate for the self contribution Cx(e,e).

It is necessary to constrain the size of N. Members of too large set N intersecting with e should not be allowed to join forces in filtering node e. This is similar to the situation discussed in the third embodiment, and the approach suggested there is preferred here too, although large Ns may be compensated for also through other means.

Each NSEC(N,e) score is used to derive, for all leaves in e*N, an attenuation factor T(N,e) between 0 and 1 that is used to attenuate (reduce in strength) the time series of the leaf. When e″ is a virtual node that contains the same leaves as in e\N together with the attenuated leaves in e*N, the attenuation factor is defined so that re-computation of the exceptionality score of e″ is equal to X(e)−NSEC(N,e). This provides an approximation of the exceptionality on e after the exceptionality contributed to e by N, Cx(N,e), given the set of intersecting nodes in N, for each N contained in I(e), is removed.

The application of a multiplicative factor to all points of a time series of any node m results with a series having the same exceptionality strength at every point as the original time series. However, the exceptionality of any parent node p of m, where both p and m are exceptional in the same direction, provided m is more exceptional than p, is expected to decrease. Note that m is assumed to be more exceptional than p as N was determined to positively interact with e. Only if the correlation of m and p is 1 will the parent exceptionality not change. In all other cases, for correlations greater than or equal to −1, the smaller the correlation of m and p, the more probable is a decrease of the parent exceptionality (to the extent controlled by the size of the attenuation factor), thus the less likely it is for the parent to be a focal point. A complementary observation is that the smaller the correlation of m and p the smaller is the belief that the exceptionality of the leaf is attributed to p and the more the exceptionality of m is considered to be induced by one or more nodes intersecting with p.

There are several approaches to computing T(N,e). One applies standard numerical approximation techniques, where the explicit function is not available, such as a binary search. A second method may be viewed as a sub-case of the first, leveraging linearity assumptions and involving iterative numerical correction process. A third method is analytic. Examples of the later two are described below.

The first method is numeric, involving running a type of a “search” algorithm with numerical approximation. ΔX₀ is defined as NSEC(N,e), which is the target decrease in the exceptionality of e after its attenuation. Assuming linearity, the correct T(N,e) can be approximated by

$${T}_{1} = \frac{Δ {X}_{0}}{X ( e ) - X ( e \backslash N )}$$

Obviously, linearity does not hold in the general case—while attenuation has a linear nature, the deviation of the above result from the exact attenuation score depends on the particular prediction model used to obtain exceptionality scores, the exceptionality measure, and the specific correlation between members of N and e. Using T₁ for computing the attenuated node e₁, the resulting exceptionality difference between e and the attenuated node is defined as ΔX₁=X(e)−X(e₁). Further assuming linearity, Tᵢ₊₁ is defined as

$${T}_{i + 1} = \frac{Δ {X}_{i - 1}}{Δ {X}_{i}} \cdot {T}_{i} .$$

Iteration through this process is continued, checking for sequence convergence (based on the difference between ΔXᵢ and ΔXᵢ₋₁). If the process does not seem to converge, numerical optimization techniques may be applied to adjust the following iterations. The iterative process may also be simply stopped if for some i ΔXᵢ>ΔXᵢ₋₁.

The second method is analytic, trying to directly measure correlations in order to achieve a precision that would allow avoiding iterative calculations. The correlation between the time-series of e and e*N is denoted as c; the typical (possibly average) amplitude of residuals of time-series x is denoted as size(x); the residual of e in the last time point is denoted as r; and the standard deviation of the historical values of e is denoted as σ. It is assumed for now that the exceptionality score is standard, that is,

$$\frac{r}{σ} .$$

It is further assumed for now that complete attenuation of e*N is taking place (T(e,N)=0).

In the case of a correlation of 1, σ reduces proportionally to

$$\frac{\text{size} ( e * N )}{\text{size} ( e )} ,$$

thus

$${σ}^{′} = ( 1 - \frac{\text{size} ( e * N )}{\text{size} ( e )} ) \cdot σ .$$

In the case of a correlation of 0, the “random noise” effect on e results in σ′=σ. When the correlation is −1,

$${σ}^{′} = ( 1 - \frac{\text{size} ( e * N )}{\text{size} ( e )} ) \cdot σ .$$

From the linear nature of correlation and attenuation, it can be deduced that

$${σ}^{′} = ( 1 - c \cdot \frac{\text{size} ( e * N )}{\text{size} ( e )} ) \cdot σ$$

The residual r′ of the attenuated node is reduced proportionally to the decrease in size (assuming linearity of the exceptionality prediction model):

$${r}^{′} = ( 1 - \frac{\text{size} ( e * N )}{\text{size} ( e )} ) \cdot r$$

The exceptionality score, when complete attenuation is taking place is thus:

$$X ( {e}^{′} ) = \frac{{r}^{′}}{{σ}^{′}} = \frac{( 1 - \cdot \frac{\text{size} ( e * N )}{\text{size} ( e )} ) \cdot r}{( 1 - c \cdot \frac{\text{size} ( e * N )}{\text{size} ( e )} ) \cdot σ}$$

Now, when the attenuation is not complete, and the attenuation factor used for attenuating e*N is T, the effective size removed from e*N turns to (1−T)·size(e*N). Thus, based on the above formulas, the exceptionality with partial attenuation turns to:

$$X ( {e}^{′} ) = \frac{{r}^{′}}{{σ}^{′}} = \frac{( 1 - ( 1 - T ) \cdot \frac{\text{size} ( e * N )}{\text{size} ( e )} ) \cdot r}{( 1 - c \cdot ( 1 - T ) \cdot \frac{\text{size} ( e * N )}{\text{size} ( e )} ) \cdot σ} .$$

This value should be equal to the remaining exceptionality defined by X(e′)=X(e)−ΔX₀. This equation is thus solved for T (since r, σ, c and the sizes are measurable values, and the target X(e′) is computed above), obtaining:

$$T = 1 - \frac{X ( {e}^{′ } ) \cdot σ - r}{\frac{\text{size} ( e * N )}{\text{size} ( e )} \cdot ( X ( {e}^{′} ) \cdot σ \cdot c - r )}$$

It is possible that there are leaves that are included in intersections of more than one subset N of nodes in I(e) and e. That is, they are assigned more than one attenuation factor T(N,e). This situation is dealt with as follows.

Denote M as the set of all the checked subsets N of nodes neighboring e. A node n is called a neighbor of the examined node e, if e and n intersects and n is considered, at time of examination, a possible cause for filtering e due to their interaction. Denote S as a subset of M such that the intersection of e with the intersection of sets N in S,

$$e * ( {*}_{{N}_{i} ∈ S} {N}_{i} ) ,$$

is not empty. Using S afragment of e, F(e,S) is defined as a virtual node given by by

$$[ e * ( {*}_{{N}_{i} ∈ S} {N}_{i} ) ] / {S}^{′} ,$$

where S′ is the complement of S in M. All the leaves of F(e,S) have exactly the same set of containing nodes, all neighboring to e; hence leaves of each fragment are attenuated in the same way, but leaves of different fragments might not. Therefore, it is possible to talk about attenuation in terms of attenuation of fragments. Note that there is only one subset S in M defining a certain fragment of e, and a certain fragment is defined by one subset S, so F(e,S) may be viewed as the fragment of e that S defines.

CAF(e,S), a Common Attenuation Function, is defined to be CAF(e,S)=CAF(F(e,S))=CAF({T(N,e)}_{NεS}) CAF(e,S) provides the effective attenuation score of each fragment F(e,S), S is in M, based on the particular attenuation scores of each e*N(N is in S). The function can be viewed as one that defines the attenuation score of each leaf 1v of e based on the attenuation scores related to each of e's neighbors containing 1v.

CAF may be conservative (smallest attenuation of {T(N,e)}_{Nεs)} or radical (largest attenuation) or anything in between. The conservative approach is preferred due to its fit with the fine-grained spirit of this algorithm.

Once this is done, in order to re-compute the exceptionality score of the attenuated node e, there are a few options.

The most obvious way would be to assign, to each leaf 1v of e, the common attenuation score of the fragment 1v belongs to, or CAF(1v)=CAF(e,S), for 1v in L(F(e,S)), where L(X) refers to all the leaves contained in X. Leaf CAF scores are then applied to the time series of all leaves contained in e. Now, there are two options for computing the exceptionality of the attenuated node e′. One possibility is to simply apply the same scoring techniques used earlier. If these directly compute scores on aggregated nodes, e′ must first be aggregated from its attenuated leaves. The attenuated volume would be the sum of all the leaves 1v in L(e), each attenuated by CAF(1v):

$${e}^{′} = e - {\sum }_{lv ∈ L ( e )} lv \cdot ( 1 - CAF ( lv ) ) .$$

We can then re-compute exceptionality scores for e′. The exceptionality in e′ may also be computed as a weighted average of the exceptionality in the leaves, in which case the exceptionality scores of the attenuated leaves should be recomputed.

An alternative for rebuilding e′ involves using a variation (in fact, an extension) of the inclusion-exclusion principle. In essence, a virtual node e\N can be aggregated from its leaves using the inclusion-exclusion principle, based on the formula:

$$e \backslash N = e - {\sum }_{n ∈ N} e * n + {\sum }_{\begin{matrix}{n}_{1} , {n}_{2} ∈ N \\ {n}_{1} \neq {n}_{2}\end{matrix}} e * {n}_{1} * {n}_{2} + … + {( - 1 )}^{\vert N \vert} e * {n}_{1} * … * {n}_{\vert N \vert}$$

While having higher complexity for any single computation, it makes use of aggregations of chunks of leaves which are needed multiple times—note that the same intersection of nodes is involved in multiple interaction removal computations. Thus, the benefit of reusing such computed chunks is enabled. Note that the higher the size of e (in terms of number of leaves) and the smaller is the cardinality of I(e), the smaller the complexity advantage of the first alternative.

However, the inclusion-exclusion principle might not be applied directly, due to the need to attenuate the volume of each such chunk. That principle is thus extended as described below.

Define Ψⱼ={S:|S|=j, F(e, S) is a fragment of e}. Ψⱼ refers to all the relevant neighbor subsets of size j, each of which defines a fragment of e. It is clear that M is a disjoint union of Ψ₁, . . . ,Ψ_{|M|}. Using this notation, the aggregated volume of e′ may be defined as:

$${e}^{′} = e - {\sum }_{i = 1}^{\vert M \vert} {\sum }_{S ∈ {Ψ}_{i}} ( 1 - CAF ( e , S ) - Z ( S ) ) \cdot e * S , \\ Z ( S ) = {\sum }_{i = 1}^{\vert S \vert - 1} {\sum }_{\begin{matrix}e * S ⊆ e * {S}^{′} , \\ {S}^{′} ∈ {Ψ}_{i}\end{matrix}} ( 1 - CAF ( e , {S}^{′} ) - Z ( {S}^{′} ) )$$

Note that when e*S is contained in e*S′, e*S′*S=e*S.

The formula of Z(S) (for SεΨᵢ) is recursive, as it depends on values of Z(S′) that are calculated for subsets S′ that belong to Ψ₁, . . . ,Ψᵢ₋₁, and Z(S)=0 for SεΨ₁. As the steps of the formula for e′ (i=1,2, . . . ) are iterated through, the fragments F(e,S) for SεΨᵢ are recursively handled. It can be shown that if all attenuation scores are 0 (CAF(e,S)=0 for all S), then Z(S) alternates between 0 and 2 and the formula reduces into the classic inclusion-exclusion formula. It follows that the formula above is a general extension of the inclusion-exclusion formula for differentially incomplete removal of subgroups (or “attenuation”). The role of Z(S) is one of a correction factor, which remembers the accumulated amount of attenuation of S (positive or negative, corresponding to excessive or missing attenuation extents) contained in the temporary attenuated volume result obtained for e′ at the current step i.

In other words, Z(S) is a non-integer number, monitoring the gap in extent of attenuation that e*S has at any iteration, vs. what should have been the actual value of the attenuation of e*S at that iteration. In fact, every time a subset of neighbors S′ of e such that e*S′ contains e*S (e*S*S′=e*S) is processed, e*S is effectively attenuated by the extent (1−CAF(e,S′)−Z(S′))·e*S, as follows from the formula of e′ above. Those are the values accumulated by Z(S), and when S's turn comes while iterating through the formula for e′, it's attenuation factor CAF(e,S) is corrected exactly by the value of Z(S) accumulated till then. The complete computation may be executed iteratively, for i=1 . . . |M|, accumulating Z(S)'s of SεΨⱼ, j>i correspondingly; alternatively, it may be computed directly, having all the values of Z(S) recursively pre-computed.

This algorithm is applied to all nodes in the input set. Any node e whose attenuated score is too small may be tagged as non-focal. Any node of which the attenuated score is large enough may be tagged as a focal point. In addition to the extent of attenuated exceptionality, other criteria, such as the node severity, extent of homogeneity (if computed) and other criteria may also be used in tagging decisions. As any tagged node either eliminates or fixates interactions, a subsequent iteration of the algorithm has a better starting point. Thus while at each run multiple nodes may be tagged, it is preferable to tag only one node at a time. Various control structures may be defined to control re-runs, number of iterations, extent of tagging done in one run, stopping conditions, and provisioning for un-tagging. One possibility for such control structure is illustrated as part of the fifth embodiment.

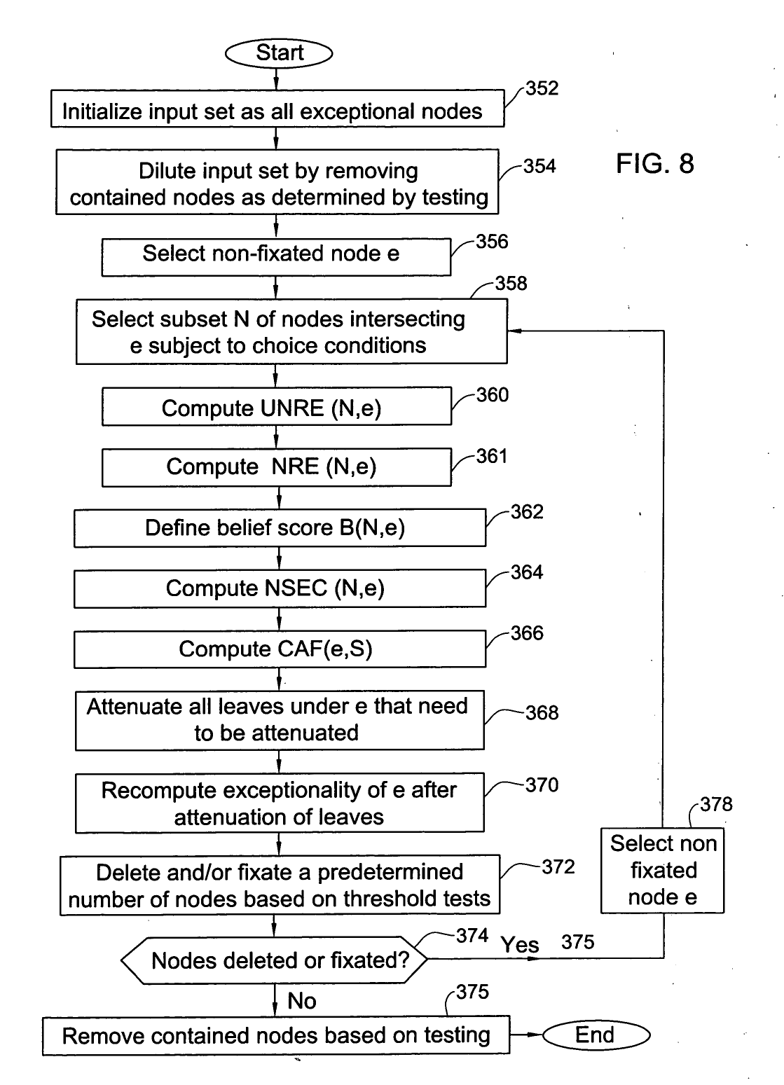

FIG. 8 shows a flow char for carrying out this embodiment of the invention. In step 352 the input set is initialized as the set of all exceptional nodes, and in step 354 the input set is diluted by removing nodes as determined by testing. A node e is then selected (step 356), and a subset N of nodes intersecting with e is selected subject to choice conditions (step 358). Then, in step 360, UNRE(N,e) is calculated and in step 361 UNRE(N,e) is corrected to produce the adjusted minimal N-reduced exceptionality. In step 362 the belief score B(N,e) is determined (step 362). After this, NSES(N,e) is computed or defined and CAF(e,S) is calculated (step 366). In step 368 all leaves under e that need to be attenuated are attenuated, and then the exceptionality of e is recomputed following the attenuation of the leaves (step 370). Then, in step 372, a predetermined number of nodes are deleted and/or removed based upon threshold tests. The process then proceeds to step 374 where it is determined whether any nodes have been deleted or fixated. If no, contained nodes are removed (step 375) and the process terminates. Otherwise, a non-fixated node is selected (step 378) and the process returns to step 358.

### Fifth Embodiment

This embodiment uses both the coarse and fine algorithms described above. A control algorithm is used that controls the activation of both algorithms. It is structured to allow variations on these algorithms as well as other algorithms dealing with removal of interactions. The control is achieved with the help of a state machine (which may be of various kinds), as specified below. The control algorithm consists of an initialization stage, a state-dependent iteration stage, and a termination stage.

The initialization stage is mainly intended to reduce the input set and thus improve scaling. In addition, it detects opportunities to divide the input set into interaction-independent clusters (sets of nodes that can be independently processed in parallel), so that the state dependent iteration phase can run on them in parallel. Each cluster is a set of unfiltered nodes S. This set is reduced as filtering of the nodes progresses. This stage initializes also the progress state ps(S), which stores the current state of the algorithm; sets the status of all nodes in S to REGULAR; initializes the result set, R(ps(S)), which contains all nodes a particular state succeeds in processing (filtering or fixating, restoring or relegating, as described below); and initializes a dynamic active set of nodes, Act(S), which is a “worktable” of the algorithm.

The state-dependent iteration stage is the core of the interactions-removal algorithm. Its objective is to iteratively filter out nodes that are identified as not being focal points as well as fixate nodes that are determined to be focal points by analyzing their inter-relations with their neighbors. Node n is called a neighbor of the examined node e, if e and n intersect and the processing state considers that n is a possible cause of filtering of e due to their interaction. Technically, what nodes can be chosen as neighbors is defined according to a choice condition that is dependent on the state.

The state dependent iteration stage also manages Act(S)—only a node found in the active set at any given time may be filtered out. The algorithm runs on all the nodes in the current active set (“global run”, and over each node's neighbors (“local run”). The success of each state is monitored, and the result set is updated. Furthermore, this stage manages state machine transitions; the state is updated due to results of the actions taken at the current state (such as filtering or fixation), together with the active set content. In addition, this stage is equipped with a detector of emergent interaction-independent clusters (similar to the one used in the initialization stage), and can branch following execution into parallel runs, on the fly.

The termination stage may be used for final removal of remaining contained events, when needed.

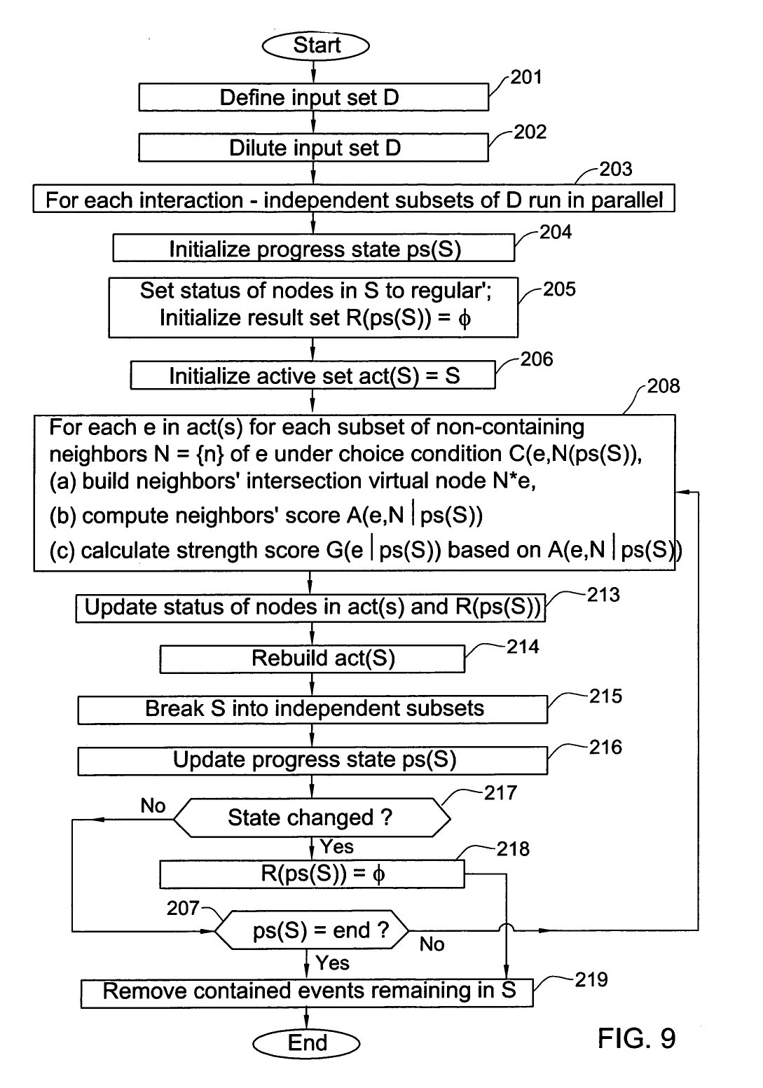

FIG. 9 shows a flow chart for the control algorithm. In step 201, the input set D of nodes is defined, and in step 202, the input set D is diluted subject to dimensionality considerations. Then, in step 203, for each interaction-independent subset S of D, in parallel, the progress state ps(S) is initialized (step 204). In step 205, the status of nodes in S is set to regular; and the result set R(ps(S)) is initialized to Ø. In step 206, the active set act(S) is set to the entire S. Now, in step 208, for each e in act(S), and for each subset of (non-containing) neighbors N={n} of e under choice condition C(e,N|ps(S)), the virtual node N*e is constructed which is the intersection of e and the union of a subset N of e's neighbors, neighbors' score A(e,N|ps(S)) are computed, and the strength score G(e|ps(S)) is computed based on A(e,N|ps(S)).

In step 213, the status of nodes in act(S) and R(ps(S)) are updated given ps(S), A(e,N|ps(S))'s, and G(e|ps(S))'s, and in step 214, act(S) is reconstructed given the status updates, ps(S) and G(e|ps(S))'s. S is now broken into independent subsets {S}(step 215), and progress state ps(S) is updated using ΔR(ps(S)) and Δact(S); In step 217 it is determined whether the state has changed. If yes, then in step 218, R(ps(S)) is set to Ø. Finally, in step 219, contained events remaining in S are removed and the process terminates. If at step 217 it is determined that the state has not changed, then the process continues to step 207 where it is determined whether PS(S)=END. If no, the process returns to step 208. Otherwise, the process continues to step 219 where contained nodes remaining in S are removed and the process terminates.

The input set D is preferably the entire set of homogenous exceptional nodes obtained after applying the homogeneity analysis of the Second embodiment. Apart for few trivial tasks, such as setting the status of all nodes to REGULAR and setting the initial state, the main initialization task is to optionally apply simple filters directed to reducing the candidate set D. One such filter may attempt to reduce the number of contained nodes in D. D can be viewed as composed of a front of nodes and a set of contained nodes. Front Fr(S) is the largest subset of nodes in S such that it does not contain any nodes X and Y such that X contains Y. Although the front set of the candidate events set is itself theoretically exponential in the number of dimensions of the cube, its size is asymptotically smaller than the total size of the candidate event set (assuming random distribution of candidate events over the cube). Moreover, the typical number of intersections of a front node is much smaller than that of a contained node, for two main reasons: 1) a contained node has at least one trivial intersection, which is its containing event; and 2) contained nodes often appear in clusters (i.e. they are intersections of each other), if their containing node is strongly homogeneous. Of course, the more intersection relations are present in the input events set, the more potential interactions there are to check.

A filter for removing contained events from D may take any one or more of several approaches. For instance, contained nodes that are not strongly exceptional with regard to the set of their containing nodes can be removed. Removal of a contained node may simply be done by iterating through the nodes in D (top-down cube-wise) and greedily filtering out a contained node if it is not more exceptional by a predetermined small amount than each of its containing nodes. A node filtered this way has very little chance of surviving the interaction-removal algorithm in any case, since it is not likely to be found as an exceptionality focus of each of its containing events (a node A is an exceptionality focus of containing node B if A is exceptional but B\A is not); therefore it will eventually be filtered out in the termination stage of the control algorithm (see below). This node may be also tested for the extent of effect it has on its neighborhood, such as by removing it from its containing nodes, to see the impact on them; if it does affect its neighborhood, it should be kept.

It is preferable to break the problem to disjoint problems that may be processed in accordance with the invention in parallel. In order for node n to interact with node e, n and e must intersect, so interaction is not transitive. Thus, the simplest way is to look at the intersection dependencies graph (a graph in which an edge exists from node n to e if n intersects with e), and identify the largest strongly connected sub-graphs in it None of the nodes in any of the subgraphs has an intersection with any node in any other subgraph. Each sub graph may be processed in parallel.

Note that re-partitioning may be applied also at the end of every global iteration (after processing all nodes in that iteration's active set). However, such re-partitioning may be limited or be impossible if restoration of filtered nodes is allowed.

Retaining contained nodes that remained may be subjected to additional testing, because of the very nature of the containment relation. The principle of elimination of the intersection of nodes A and B from A in order to assess the impact of their interaction on A is inapplicable here, since removing the intersection of a containing node and its contained node from the later results with an empty set. That is, the base fine algorithm may not effectively consider the interaction impact of a containing on the contained nodes. According to one such test, for example, each contained node that is significantly more exceptional than any of its containing nodes may be retained. In addition, the remaining contained node should be unique in nature. A unique node is an exceptional homogeneous node for which the exceptionality is much higher that that of the vast majority of its siblings under any of its parents.

As described above, the algorithmic framework allows various interaction removal algorithms to be employed, integrated within the general framework through the specifics of the chosen state machine. The following describes the mapping of the general operations defined in the framework to the algorithms for interaction removal described in previous sections, whenever these algorithms use more specific or different operations.

Coarse algorithm
Selecting N under choice condition C(e,N|ps(S)) (row 9)
Constraining the size of the subset N of nodes e in I(e), based on homogeneity considerations.
Computing neighbors' score A(e,N|ₚₛ(S)) (row 11) The neighbor score A(N,e) is simply 1 if K(N,e) is True and 0 otherwise.
Calculating strength score G(e|ps(S)) (row 12) Inactive
Updating status of nodes in act(S) (row 13) Deletion of regular nodes is executed according with the rule defined in the coarse algorithm
Rebuilding act(S) given the status updates (row 14) The active set is simply the set of undeleted nodes

Fine algorithm
Computing neighbors' score A(e,N|ps(S)) (row 11) The neighbor score A(N,e) is defined to be the attenuation score T(N,e)
Calculating strength score G(e|ps(S)) (row 12) The base strength score G(e) is the updated exceptionality strength score of the attenuated node e. This score may be combined with other scores to get the score used in testing for deletion and fixation. For instance, if we want to delete k nodes at a time, we can get a score that takes into consideration the exceptionality strength as well as the level of interdependence of these k nodes on one another (see below).
Updating status of nodes in act(S) (row 13)

The update rule is different for the deletion and fixation stages, although symmetrical in essence. In the deletion stage, node/s with the lowest strength scores (and lower than a pre-defined low strength threshold) are filtered out; in the fixation stage, node/s with the highest strength scores (and higher than another pre-defined high strength threshold) are fixated.

A decision should be made with respect to how many nodes to delete or fixate (depending on stage) in the same time. On one hand, handling more than one node at a time may greatly enhance performance, but on the other, robustness, and hence accuracy, might be reduced in this case. The quality drop may be avoided to a large degree when multiple nodes are deleted or fixated together by verifying that any two deleted or fixated nodes do not intersect.
Rebuilding act(S) given the status updates (row 14)
The update rules of the active set should put into act(S) all and only the nodes whose status may change by the algorithm during the next global iteration. The active set is assigned as following, assuming that backtracking (see below) is not employed:
   Empty the active set;
   Add all the regular nodes whose strength is lower than the low strength threshold;
   Add all the regular nodes whose strength is higher than the high strength threshold;
   Add all the neighbors of the nodes whose status have been changed during the last update.
   When using also backtracking states, the rule might change. Additional discussion on the impact of such states is provided below.

The State Machine

The state machine controls the algorithm flow and allows for supporting a wide array of implementations of the framework and various state tables, and it impacts the various operations employed by the framework, based on the algorithms used in any state, as demonstrated above. In particular, the state machine controls the update of the status of nodes in the active set based on strength scores G(e) and neighbor scores A(N,e).

In a preferred embodiment of the state machine a node's status may be one of the 3: REGULAR, FILTERED, FIXATED (additional statuses may be added if needed). There are 2 pairs of opposite operations which may be possibly applied by the machine to each node (according to its current status): deletion (REGULAR->FILTERED) vs. restoration (FILTERED->REGULAR) and fixation (REGULAR->FIXATED) vs. relegation (FIXATED->REGULAR). A status of a node implies the significance of a node as a meaningful neighbor of other nodes. The statuses are interpreted by all the machine states in the same way.

When backtracking states are not used, filtered and fixated nodes may not be members of act(S); a filtered node may not be a valid neighbor of a member of act(S); and a regular node may appear in act(S) as well as be a neighbor of a member of act(S), and may be subject to filtering or fixation.

When backtracking is allowed, it is possible that a node A, filtered, for example, because of its interaction with node B, would be “unfiltered” (restoring its earlier status) if B is later filtered too. A similar consideration applies to fixated nodes. Once backtracking is enabled, deleted nodes may be added back into the active set (restoration) and fixated nodes may be re-tagged as regular and added into the active set (relegation). More importantly, restoration and relegation may need to be performed in a stochastic fashion, e.g. for each x deleted nodes, y (smaller than x) are randomly restored. This capability allows achieving much better robustness in light of the final objective, by “stirring” the active set a little, in the style of simulated annealing. Note that a node that was filtered “justly” would eventually be filtered out again even if added back at a certain stage. But a node that was filtered out “unjustly”, because of its temporarily unfavorable relations with still unfiltered neighbors, will have a chance to return and impact subsequent processing.

The transfer function of the state machine depends on the changes that occur to the result set of a particular state (ΔR(ps(S)) or ΔR) and to the active set of the nodes (Δact(S) or Δact) during the last global iteration within this state. Of course, each machine state defines differently its implementation of the transfer function.

In a preferred implementation, and assuming backtracking states are not utilized, there are 3 processing states in the state machine (not including the obvious start and final state, named, START and END): COARSE, DELETION, and FIXATION.

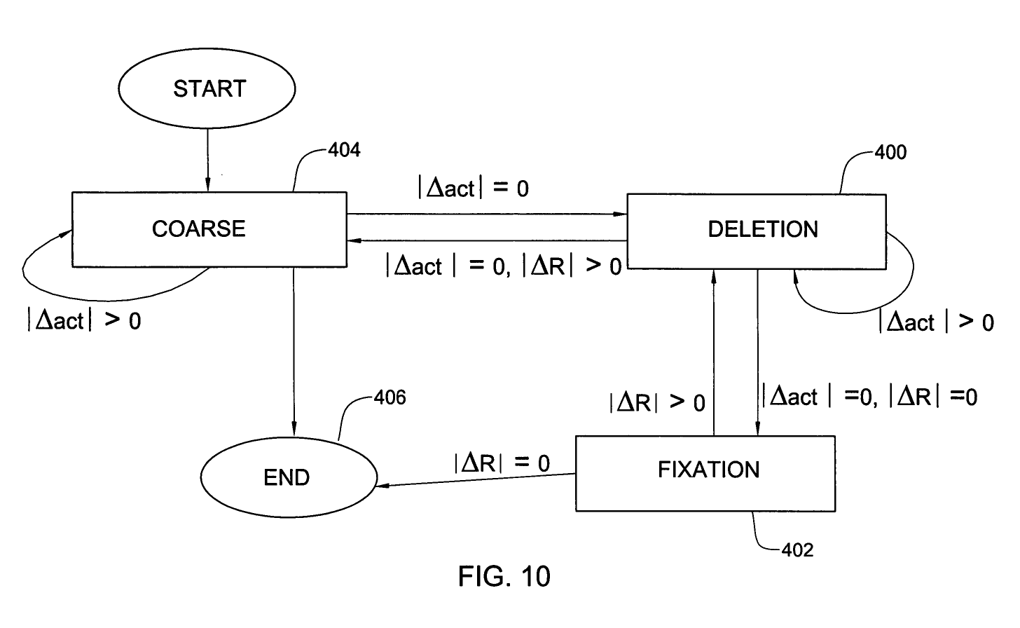

FIG. 10 shows the state machine corresponding to this implementation. The machine starts at the COARSE state 404; the initial active set is the entire input set (subject to its partitioning for parallelization). While there are changes in the active set, the machine remains at the COARSE state 404; during this stage, nodes are being filtered as dictated by the coarse algorithm (the exact processing logic is detailed above in the third embodiment). As soon as the active set stops changing, the machine moves into the DELETION state 400, which is the domain of the fine algorithm. At this stage the system filters the less-probable focal points until it has no further confidence in doing so, i.e. the deletion phase stops and the control moves back to the COARSE state 404 (if some nodes have been deleted) or to the FIXATION state 402 (otherwise). At this stage, which is the domain of the fine algorithm too, the system tries to detect nodes highly trusted to be correct focal points. If it succeeds in fixating at least one such node, the control moves back to the DELETION state 400; otherwise the system moves into the END state 406.

Clearly many other state machines may be used with this embodiment of the invention, as explained above. For example, the machine can function, in principle, without the FIXATION state altogether.

### Sixth Embodiment—Pattern Recognition

In this embodiment, pattern detection is carried out. It is assumed that:

A time series is provided.

A size k of a time window, ending at Tc, the current time point, has been determined.

For each point tᵢ in the time window, given time series data for all earlier time points tⱼ, tⱼ<tᵢ, exception scoring has been carried out and residuals have been determined.

Cancellation Pattern

The cancellation pattern (CP) is characterized by an exceptional increase or decrease in the target measure values which can be explained by an adjustment of a decrease or increase in the measure's value at previous time. From a business aspect, such phenomena may often represent self-correcting phenomena (such as advanced purchasing or “pantry loading”), which might be of no interest to users. When a Cancellation pattern is detected, we may either tag the exception or adjust (decrease) the exception size.

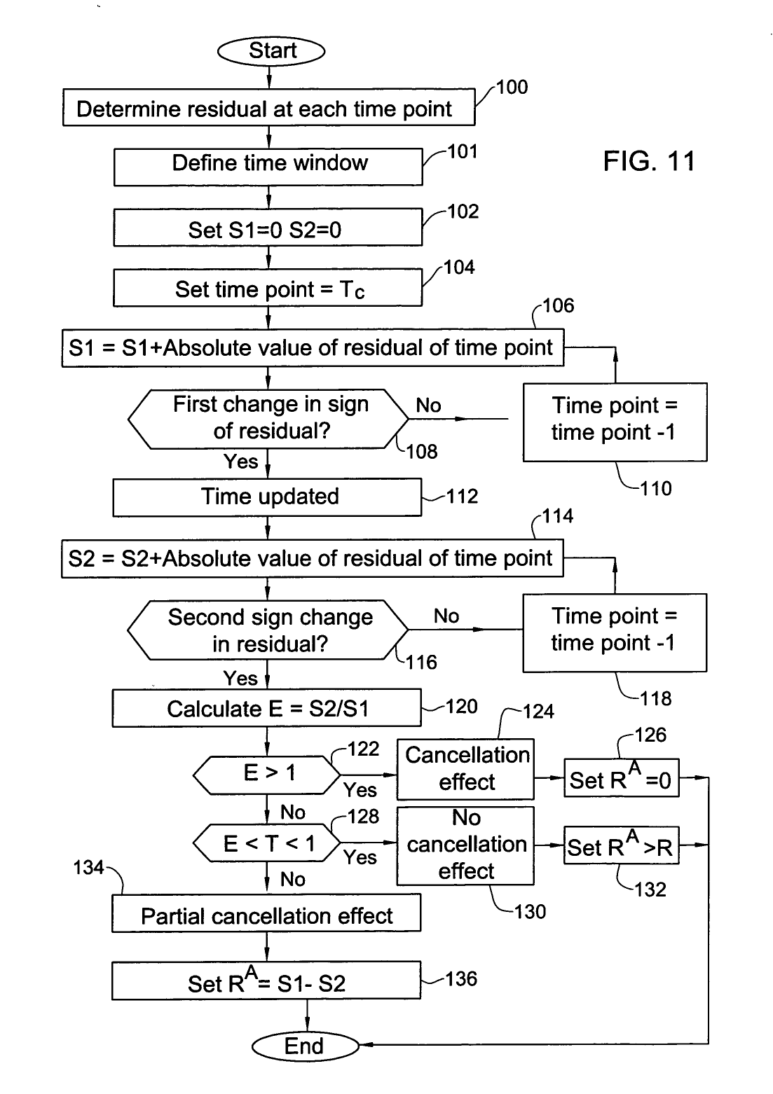

Various techniques may be used to detect such a pattern. FIG. 11 shows a flow chart for a method of pattern recognition in accordance with the invention that may be employed with exceptionality scoring results with prediction model residuals for detecting a cancellation pattern:

In step 100, a residual is determined at each time point, and in step 101, a time window is defined. In step 102, two sums, S1 and S2, that will be used to sum up positive and negative residuals, are set to 0. In step 104, the time point is set to the current time Tc. In step 106, S1 is reset to the sum of S1 and the absolute value of the residual of the time point. Then in step 108 it is determined whether a first change in the sign of the residual has occurred. If no, the time point is updated by setting the value of the time point to one less than the present value (step 110), and the process returns to step 106. If at step 108 it is determined that a first change in the sign of the residual has occurred, the time point is updated (step 112) and the process continues to step 114, at which the value of S2 is reset to the sum of S2 and the absolute value of the residual of the time point. At step 116 it is determined whether a second change in the sign of the residual has occurred. If no the time point is updated (step 118) and the process returns to step 114. Otherwise the process continues to step 120 and the ratio E+S2/S1 is calculated.

In step 122, it is determined whether E>1. If yes, a cancellation effect has been identified (step 124), R^{A} is set to 0 (step 126) and the process terminates. If in step 122, it is determined that E is not greater than 1, then in step 128, it is determined whether E<T<1. If yes, then no cancellation effect has been identified (step 132), RA is set to R (step 132), and the process terminates. If at step 128 it is determined that the condition E<T<1 is not true, then a partial cancellation effect has been identified (step 134), RA is set to S1-S2 (step 136) and the process terminates.

Back To Normal

The pattern of this phenomenon is characterized by a recent change (increase or decrease) in the measure values and after a limited number of time points, a return (decrease or increase, respectively) of the measure values to the normal level (close enough to expected values). A typical example would be a decrease in sales occurring after a certain holiday, where few time periods before the holiday there was an increase in sales

In such a situation it is often required to ignore the occurrence, or decrease the size of an exception detected when the measure value returns to normal level. In essence, the exception may be explained, fully or partially, by the Back to Normal phenomena, and thus it might not be interesting, or be of reduced interest to users. Optionally, in such a case it may be required to report the occurrence of the Back to Normal phenomena as a special pattern associated with the exception.

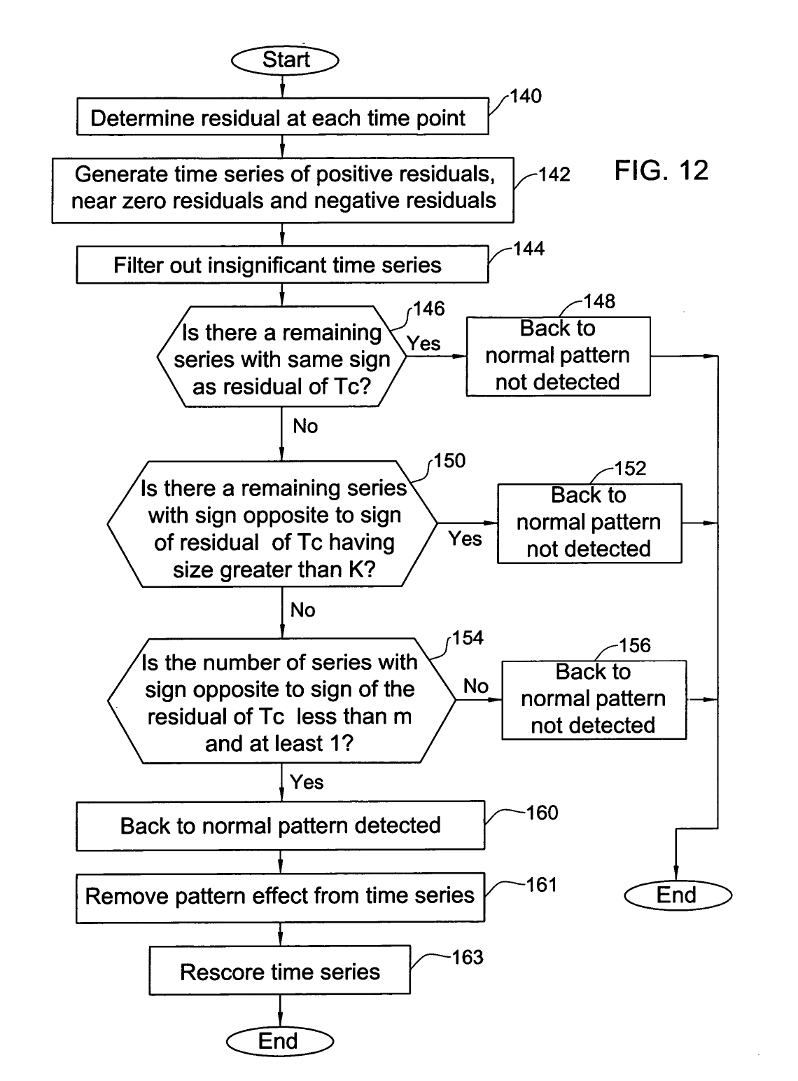

FIG. 12 shows a flow chart of a method for detecting a back to normal pattern in accordance with one embodiment of the invention.

In step 140, all points in the detection time window are visited in sequence, and in step 142, the residuals obtained for them are assigned to distinct series of three different types: positive, near-zero and negative residuals (where the residuals may be normalized). Any series which is not wholly contained within the detection time window as well as the series closest to Tc is ignored. In step 144, any such series which is insignificant (assumed to be noise) is filtered out. Any technique for this may be used, such as eliminating a series in which the largest residual value or the median of all residual values has a small enough percentile within all residuals in the detection time window or whole history; or use the average of sum of residuals in a series as a criterion, comparing it to all the average of sums of all other series.

In step 146 it is determined whether there is a remaining series with the same sign as the residual of Tc. If yes, then in step 148 a back to normal pattern has not been identified and the process terminates. If no, then in step 150, it is determined whether there is a remaining series having a sign opposite that he sign of the residual of Tc and size greater than a predetermined value k. If yes, then in step 152 a back to normal pattern is not detected and the process terminates. If no, then in step 154, it is determined whether the number of series having a sign opposite to the sign of the residual of Tc is less than a predetermined value m (typically very small, often 1). If no, then in step 156, aback to normal pattern has not been detected, and the process terminates. If yes, then in step 160 a back to normal pattern is concluded to have been detected. The pattern is then removed from the time series (step 161), the time series is rescored (step 163), and the process terminates.

Various additional variations to the above algorithm are possible. For instance, detection of multiple Back to Normal patterns reversing one another may be supported by leveraging subtraction of areas contained in those patterns elements.

Once a Back to Normal pattern is identified, it may be used to adjust Tc's residual value and exception size, and possibly eliminate the exception altogether. In order to do that it is required to re-compute the exceptionality scores after adjusting the time series, by removing, or correcting, the time points involved in the detected pattern.

If, after doing so, exception is no longer exhibited on Tc, the original exception is filtered out. In this case the occurrence of a Back to Normal pattern at Tc may still be indicated, as long as the Back to Normal pattern ends close enough to Tc (typically not earlier than one time point) and as long as Tc is at least near-exceptional. In essence, this situation represents a weaker notion of a spike exception that is fully compensated for by the detected Back to Normal pattern occurring earlier.

Continuity and Recurrence

When an exception is detected on a time series (passing the testing threshold) it may be possible that this exception continues an exception detected earlier in the time series or even continues a phenomenon that did not pass the exceptionality testing threshold but was very close to it (near-exception). From a user perspective this sometimes means that the current exception may be of lower importance, being less unexpected, to the extent that it may even need to be filtered out or at least to be tagged as continuing. The opposite may also be true: in some cases the exception must not be reported unless it represents a continuation of an earlier exception or near-exception, as in those cases non-continuing exceptions (spikes) represent uninteresting phenomena.

Likewise, an exception may represent a recurrence of recent phenomena, possibly one that was only near-exception. If a time series is determined to have an exception in the current time point, but a similar exception occurred close enough in time (once or more), the current exception may be of lower or no importance to users, as it is less unexpected. Recurrence differs from continuation in that there must be at least one time point between Tc and the earlier occurrence of the exception in which there was either no exception or an exception in the opposite direction.

An exception e1 occurring at time Tc is a continuation of an earlier exception or near-exception e2 occurring no earlier than k time points from Tc, k being small enough, if e1 and e2 are in the same direction, and there is no point in time t between them, tc−k<t<tc, in which there is no exception or near-exception in the same direction.

An exception e1 occurring at time Tc is a recurrence of an earlier exception or near-exception e2 occurring no earlier than k time points from Tc, k being small enough, if e1 and e2 are in the same direction, and there is a point in time t between them, tc−k<t<tc, in which there is no exception or near-exception in the same direction or there is an exception or near-exception in the opposite direction. As both Continuity and Recurrence may be exhibited in a certain time window, it is needed to decide on a detection policy. The simplest is to regard Continuity and Recurrence as mutually exclusive, giving precedence to one over the other. Detection of the patterns following this policy is described below.

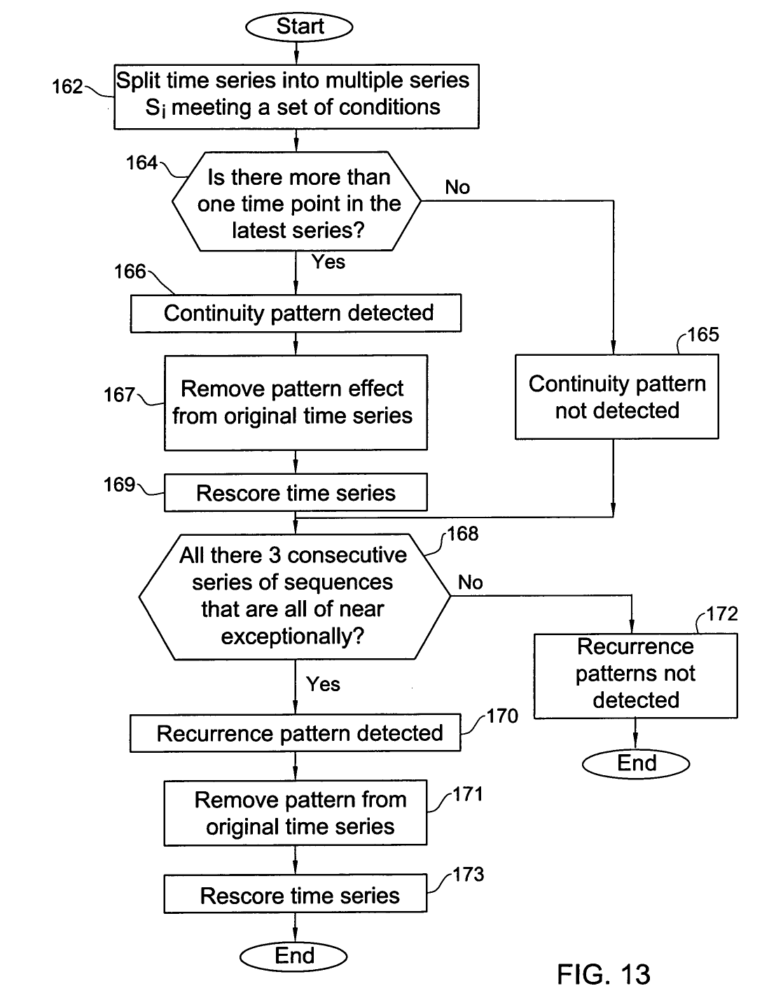

FIG. 13 shows a method for detecting continuity and recurrence patterns, in accordance with the invention. In step 162, the time series is split to multiple series Si, i=1, . . . ,m, such that each Si is the largest possible series meeting the following:
it contains only consecutive time points;
the exceptionality scores of all of its time points are all in the same direction (that is, the residuals are all having the same sign); and
the exceptionality scores of all of its time points are either all above the near-exceptionality threshold or all below it.

In step 164, it is determined whether there is more than one time point in the lates series (that is, not only Tc). If yes, then in step 166 it is concluded that a continuity pattern has been detected. The pattern is removed from the time series (step 167), the time series is rescored (step 169), and the process terminates. If no, then in step 168, it is determined whether there is a sequence of series Sn, Sn-1, Sn-2, where Sn is the time of the series S containing Tc, that are all of near-exceptional points. (Series Si is defined as later than series Sj if the latest time point in Si is later than the latest time point is Sj) This implies, based on the definition of these series, that residuals in Sn-1 are in different direction than those in Sn and Sn-2. If yes, then in step 170 it is concluded that a recurrence pattern has been detected. The pattern is removed from the time series (step 171), the time series is rescored (step 173), and the process terminates. If at step 168 the answer is no, then, continuity and recurrence patterns are not detected (step 172) and the process terminates.

Various extensions are possible. For instance, Recurrence detection may be extended to detect multiple recurrences. Furthermore, noise elimination techniques may be used to filter a series when necessary. In addition, the method may be extended to support detection of both Recurrence and Continuity in the same time window.

When such patterns are detected, the exceptionality score may be adjusted to reflect the extent of the occurrence of the phenomenon, similarly to the previous patterns.

1. A method for analyzing multidimensional data comprising:
(d) assigning an exceptionality score to one or more nodes in the multidimensional data;
(e) identifying one or more exceptional nodes among the scored nodes; and
(f) identifying one or more focal point nodes from among the exceptional nodes, a focal point node being an exceptional node whose coordinates define a location at which an event occurred that caused the node to be exceptional.

2. A method for determining whether a selected exceptional node e in multidimensional data is a focal point node, the exceptional node having an exceptionality score, comprising:
(a) determining a direct component and one or more indirect components of the exceptionality score of the node e, the direct component representing a direct contribution of the an event occurring at a location identified by the coordinates of the node e, and the indirect component representing indirect contributions of events occurring at one or more locations identified by the coordinates of other nodes on the exceptionality score of the selected node; and
(b) determining whether the node e is a focal point node based upon one or both of the direct component and the one or more indirect components.

3. The method according to claim 2 wherein the step of determining a direct component and one or more indirect components of the exceptionality score of the node e involves a homogeneity analysis of e and one or more of the node e's children.

4. The method according to claim 3 wherein the homogeneity analysis involves creating a first virtual node by deleting from the database a set S of size k of supporting children of e and scoring the virtual node.

5. The method according to claim 4 further comprising creating a second virtual node by deleting from the database supporting children of the node e not in the set S and scoring the second virtual node.

6. The method according to claim 5 wherein the node e is determined not to be homogeneous if the difference of the score of the node e and the score of the first virtual node is significant and the difference of the score of the node e and the score of the second virtual node is not significant.

7. The method according to claim 3 wherein the homogeneity analysis involves creating a virtual node by deleting from the database a set S of nodes of all supporting children of the node e and scoring the virtual node.

8. The method according to claim 7 further wherein the node e is determined not to be homogeneous if the difference of the score of the node e and the score of the virtual node is significant.

9. The method according to claim 3 wherein the homogeneity analysis involves generating one or more Pareto subsets of children of the node e and one or more exceptionality thresholds.

10. The method according to claim 9 wherein a binomial test is run if the ratio of the volume of the children in a Pareto subset to the volume of the node e is greater than a first predetermined threshold and the ratio of the total volume of the supporting children of the node in the Pareto subset to the total volume of the Pareto subset is greater than a second predetermined threshold.

11. The method according to claim 10 wherein the null hypothesis of the binomial test is that exceptions on the children of the node e have occurred independently of one another.

12. The method according to claim 11 wherein the node e is concluded to be homogeneous if the null hypothesis is rejected by the binomial test.

13. The method according to claim 3 wherein the homogeneity analysis involves calculating a first ratio of a volume of a child of the node e to the volume of the node e and a second ratio of the child's residual to the residual of node e.

14. The method according to claim 13 further comprising obtaining an estimator for a truncated Pareto distribution based upon the first and second ratios.

15. The method according to claim 14 further comprising calculating one or more homogeneity scores based upon the obtained estimator.

16. The method according to claim 2 comprising defining a binary relation K(N,e) where K(N,e) takes on the value “true” if e\N is not sufficiently exceptional, and takes on the value “false” otherwise.

17. The method according to claim 16 wherein the node e is considered not to be a focal point node if there exists a set of nodes N intersecting e satisfying a predetermined constraint on its size such that K(N,e) is true and for each n in N, and for each set X of nodes intersecting with n, K(X,n) is false.

18. The method according to claim 17 wherein N does not satisfy the predetermined size constraint if N*c makes e pass a homogeneity test, where c is the set of all children of the node e.

19. The method according to claim 2 comprising calculating an unadjusted minimal N-reduced Exceptionality score UNRE(N,e) for a subset of nodes N intersecting e, where UNRE(N,e) is the exceptionality of e\N resulting from the set of leaves that are descendents of e but not of the nodes of N.

20. The method according to claim 19 further comprising steps of attenuating one or more leaves under the node e, recomputing the exceptionality score of e, and determining whether e is a focal point node based upon the recomputed score.

21. The method according to claim 2 comprising:
(a) using a state machine having a number of states, each state having an associated algorithm for detecting focal point nodes; and
(b) using a control algorithm for determining the state of the state machine.

22. The method according to claim 21 comprising:
(a) using a state machine having a first state running a coarse algorithm for focal point node detection and one or more additional states, each additional state running an associated fine algorithm for focal point node detection; and
(b) using a control algorithm for determining the state of the state machine

23. The method according to claim 2 comprising:
(c) defining an input set D of nodes;
(d) diluting the input set D;
(e) determining interaction-independent subsets S of the diluted set D and further processing the sets S in parallel;
(f) using one or more state machine-controlled algorithms for identifying focal point nodes in the diluted input set; and
(g) removing insignificant contained nodes from the input set

24. The method according to claim 21 wherein each state iterates over the nodes, deleting nodes that are not focal points by changing their status to deleted or otherwise updating their status, according to an independent logic of the state machine.

25. The method according to claim 24 wherein each state manages a currently checked active set of nodes and iterates over nodes in the active set of nodes, and updates its content according to changes of statuses of nodes.

26. The method according to claim 25 wherein, for each node e in the active set, updating the status of node e depends on a relative extent of a strength score where the strength score depends on a neighbor's score that scores an extent of impact a neighbors' subset N of e has on the exceptionality of e.

27. A method for scoring a multidimensional database, one or more dimensions of the database having an “all” coordinate, the data being arranged in a hierarchy of levels according to the number of “all” coordinates of nodes in the hierarchy, comprising:
(a) assigning one or more exceptionality scores to nodes in the p lowest levels of the hierarchy, where p is an integer; and
(b) assigning one or more exceptionality scores to nodes in levels of the hierarchy above the p lowest levels in an iterative process based upon the scores assigned to the p lowest levels.

28. In an n dimensional database having a time dimension having coordinates t1 to tₖ, a method for scoring a node in the database having coordinates i₁, i₂, . . . ,iₙ₋₁, iₙ=tₖ, the node having an associated actual data value, comprising;
(a) predicting a value of the data value of the node i₁, i₂, . . . ,iₙ₋₁, iₙ=tₖ based upon the data values of the nodes i₁, i₂, . . . ,iₙ₋₁, iₙ=tⱼ for j from 1 to k-1; and
(b) assigning an exceptionality score to the node i₁, i₂, . . . iₙ₋₁, iₙ=tₖ based upon the predicted value and the actual value of the node i₁, i₂, . . . ,iₙ₋₁, iₙ=tₖ.

29. The method according to claim 23 further comprising;
(a) detecting a predetermined pattern in the time sequence of nodes i₁, i₂, . . . ,iₙ₋₁, iₙ=tⱼ for j from 1 to k; and
(b) adjusting the scores of the time sequence based upon a strength of the detected pattern.

30. The method according to claim 23 wherein the step of adjusting the time sequence comprises;
(a) detecting a predetermined pattern in the time sequence of nodes i₁, i₂, . . . ,iₙ₋₁, iₙ=tⱼ for j from 1 to k; and
(b) removing the pattern effect from the time sequence i₁, i₂, . . . ,iₙ₋₁, iₙ=tⱼ for j from 1 to k to generate a revised time sequence; and
(c) scoring the revised time sequence.

31. The method according to claim 24 wherein the pattern is selected from the group comprising a back to normal pattern, a cancellation pattern, a continuation pattern, and a recurrence pattern.

32. The method according to claim 25 wherein the pattern is selected from the group comprising a back to normal pattern, a cancellation pattern, a continuation pattern, and a recurrence pattern.

33. A program storage device readable by machine, tangibly embodying a program of instructions executable by the machine to perform method steps for analyzing multidimensional data comprising:
(a) identifying one or more exceptional nodes among the scored nodes; and
(b) identifying one or more focal point nodes from among the exceptional nodes, a focal point node being an exceptional node whose coordinates define a location at which an event occurred that caused the node to be exceptional.

34. A computer program product comprising a computer useable medium having computer readable program code embodied therein for analyzing multidimensional data the computer program product comprising:
computer readable program code for causing the computer to identify one or more exceptional nodes among the scored nodes; and
computer readable program code for causing the computer to identify one or more focal point nodes from among the exceptional nodes, a focal point node being an exceptional node whose coordinates define a location at which an event occurred that caused the node to be exceptional.

35. A program storage device readable by machine, tangibly embodying a program of instructions executable by the machine to perform method steps for determining whether a selected exceptional node e in a multidimensional array of data is a focal point node, the exceptional node having an exceptionality score, comprising:
(a) determining a direct component and one or more indirect components of the exceptionality score of the node e, the direct component representing a direct contribution of the an event occurring at a location identified by the coordinates of the node e, and the indirect component representing indirect contributions of events occurring at one or more locations identified by the coordinates of other nodes on the exceptionality score of the selected node; and
(b) determining whether the node e is a focal point node based upon one or both of the direct component and the one or more indirect components.

36. A computer program product comprising a computer useable medium having computer readable program code embodied therein for determining whether a selected exceptional node e in a multidimensional array of data is a focal point node, the exceptional node having an exceptionality score, the computer program product comprising:
computer readable program code for causing the computer to determine a direct component and one or more indirect components of the exceptionality score of the node e, the direct component representing a direct contribution of the an event occurring at a location identified by the coordinates of the node e, and the indirect component representing indirect contributions of events occurring at one or more locations identified by the coordinates of other nodes on the exceptionality score of the selected node; and
computer readable program code for causing the computer to determine whether the node e is a focal point node based upon one or both of the direct component and the one or more indirect components.

37. A program storage device readable by machine, tangibly embodying a program of instructions executable by the machine to perform method steps for scoring a multidimensional database, one or more dimensions of the database having an “all” coordinate, the data being arranged in a hierarchy of levels according to the number of “all” coordinates of nodes in the hierarchy, comprising:
(a) assigning one or more exceptionality scores to nodes in the p lowest levels of the hierarchy, where p is an integer; and
(b) assigning one or more exceptionality scores to nodes in levels of the hierarchy above the p lowest levels in an iterative process based upon the scores assigned to the p lowest levels.

38. A computer program product comprising a computer useable medium having computer readable program code embodied therein for scoring a multidimensional database, one or more dimensions of the database having an “all” coordinate, the data being arranged in a hierarchy of levels according to the number of “all” coordinates of nodes in the hierarchy, the computer program product comprising:
computer readable program code for causing the computer to assign one or more exceptionality scores to nodes in the p lowest levels of the hierarchy, where p is an integer; and
computer readable program code for causing the computer to assign one or more exceptionality scores to nodes in levels of the hierarchy above the p lowest levels in an iterative process based upon the scores assigned to the p lowest levels.

39. A program storage device readable by machine, tangibly embodying a program of instructions executable by the machine to perform method steps for scoring in an n dimensional database having a time dimension having coordinates t₁ to tₖ a node in the database having coordinates i₁, i₂, . . . iₙ₋₁, iₙ=tₖ, the node having an associated actual data value, comprising;
(a) predicting a value of the data value of the node i₁, i₂, . . . ,iₙ₋₁, iₙ=tₖ based upon the data values of the nodes i₁, i₂, . . . ,iₙ₋₁, iₙ=tⱼ for j from 1 to k−1; and
(b) assigning an exceptionality score to the node i₁, i₂, . . . iₙ₋₁, iₙ=tₖ based upon the predicted value and the actual value of the node i₁, i₂, . . . ,iₙ₋₁, iₙ=tₖ.

40. A computer program product comprising a computer useable medium having computer readable program code embodied therein for scoring in an n dimensional database having a time dimension having coordinates t1 to tk, a node in the database having coordinates i₁, i₂, . . . ,iₙ₋₁, iₙ=tₖ, the node having an associated actual data value, the computer program product comprising:
computer readable program code for causing the computer to predict a value of the data value of the node i₁, i₂, . . . ,iₙ₋₁, iₙ=tₖ based upon the data values of the nodes i₁, i₂, . . . ,iₙ₋₁, iₙ=tⱼ for j from 1 to k−1; and
computer readable program code for causing the computer to assign an exceptionality score to the node i₁, i₂, . . . ,iₙ₋₁, iₙ=tₖ based upon the predicted value and the actual value of the node i₁, i₂, . . . , iₙ₋₁, iₙ=tₖ.
